(19) United States
(12) Patent Application Publication
(10) Pub. No.: US 2021/0365914 A1
(43) Pub. Date: Nov. 25, 2021

(54) INFORMATION PROCESSING APPARATUS AND INFORMATION PROCESSING METHOD

(71) Applicant: TOSHIBA TEC KABUSHIKI KAISHA, Tokyo (JP)

(72) Inventor: Ryosuke OE, Mishima Shizuoka (JP)

(21) Appl. No.: 17/200,641

(22) Filed: Mar. 12, 2021

(30) Foreign Application Priority Data
May 21, 2020 (JP) 2020-088654

(51) Int. Cl. G06Q 20/20; G06Q 20/40; G08B 3/10

(52) U.S. Cl. CPC G06Q 20/20; G08B 3/1016; G06Q 20/401

(57) ABSTRACT

In accordance with an embodiment, an information processing apparatus is carried by an operator inside and outside a predetermined area and processes information for a transaction in accordance with an operation of the operator inside the predetermined area. The information processing apparatus determines an identifier input by an input device as an identifier of a transaction target when it has been detected that the operator is present inside the predetermined area and a movement of the operator has not been detected.

### CROSS-REFERENCE TO RELATED APPLICATION

This application is based upon and claims the benefit of priority from the prior Japanese Patent Application No. 2020-088654, filed on May 21, 2020, the entire contents of which are incorporated herein by reference.

### FIELD

An embodiment described here generally relates to an information processing apparatus and an information processing method.

### BACKGROUND

A transaction processing system in which transaction contents are registered in accordance with an operation performed by a customer on a mobile terminal device is considered as a cart POS system, a smartphone POS system, or the like, for example. In such a system, it is unfavorable that the customer is focused upon operations on the mobile terminal device during movement. In such circumstances, it has been desired to prevent an operator such as a customer from being focused upon operations during movement.

### BRIEF DESCRIPTION OF THE DRAWINGS

FIG. 1 is a block diagram showing a schematic configuration of a transaction processing system according to an embodiment.

FIG. 2 is a block diagram showing a circuit configuration of a store server in the transaction processing system according to the embodiment.

FIG. 3 is a block diagram showing a circuit configuration of a virtual POS server in the transaction processing system according to the embodiment.

FIG. 4 is a block diagram showing a circuit configuration of a mobile controller in the transaction processing system according to the embodiment.

FIG. 5 is a diagram schematically showing a main data structure of a data record included in a transaction management database of the mobile controller according to the embodiment.

FIG. 6 is a diagram schematically showing a main data structure of a data record included in a registration database of the mobile controller according to the embodiment.

FIG. 7 is a block diagram showing a circuit configuration of a communication server of the transaction processing system according to the embodiment.

FIG. 8 is a block diagram showing a circuit configuration of a user terminal of the transaction processing system according to the embodiment.

FIG. 9 is a flowchart of information processing performed by the processor of the user terminal according to the embodiment.

FIG. 10 is a flowchart of information processing performed by the processor of the user terminal according to the embodiment.

FIG. 11 is a flowchart of information processing performed by the processor of the user terminal according to the embodiment.

FIG. 12 is a flowchart of information processing performed by the processor of the user terminal according to the embodiment.

FIG. 13 is a flowchart of information processing performed by the processor of the user terminal according to the embodiment.

FIG. 14 is a flowchart of information processing performed by the processor of the mobile controller according to the embodiment.

FIG. 15 is a flowchart of information processing performed by the processor of the mobile controller according to the embodiment.

FIG. 16 is a flowchart of information processing performed by the processor of the mobile controller according to the embodiment.

FIG. 17 is a flowchart of information processing performed by the processor of the mobile controller according to the embodiment.

FIG. 18 is a diagram showing an example of a list screen according to the embodiment.

FIG. 19 is a diagram showing an example of a registration screen according to the embodiment.

FIG. 20 is a diagram showing an example of a warning screen according to the embodiment.

FIG. 21 is a diagram showing an example of a list screen according to the embodiment.

FIG. 22 is a diagram showing an example of a check-out screen according to the embodiment.

### DETAILED DESCRIPTION

In accordance with one embodiment, an information processing apparatus is carried by an operator inside and outside a predetermined area and processes information for a transaction in accordance with an operation of the operator inside the predetermined area. The information processing apparatus includes an input device, a first detection device, a second detection device, and a processor. The input device inputs an identifier of a transaction target in accordance with an operation performed by the operator. The first detection device detects whether or not the operator is present inside the predetermined area. The second detection device detects a movement of the operator. The processor determines the identifier input by the input device as the identifier of the transaction target when the first detection device has detected presence of the operator and the second detection device has not detected the movement of the operator.

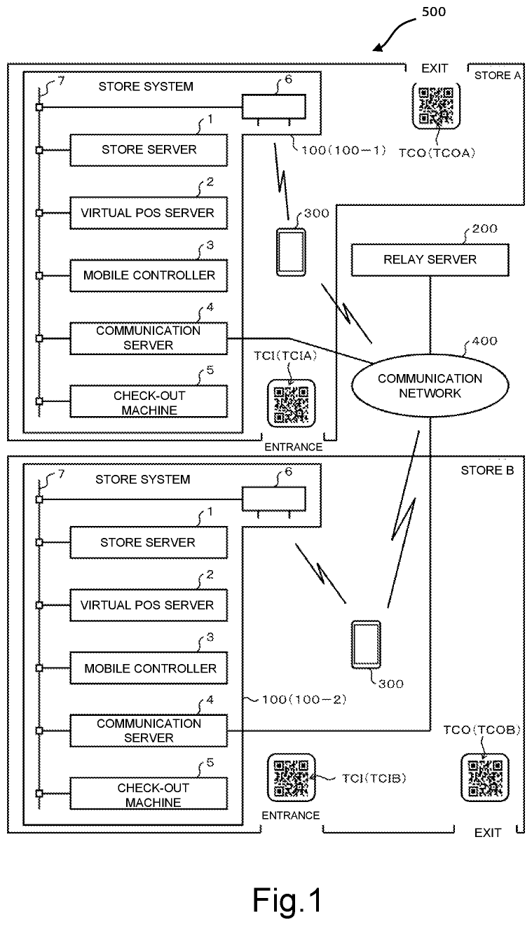

Hereinafter, a transaction processing system according to an embodiment will be described with reference to the drawings. The same reference signs in the figures will denote the same or similar portions. FIG. 1 is a block diagram showing a schematic configuration of a transaction processing system 500 according to this embodiment. The transaction processing system 500 includes a plurality of store systems 100, a relay server 200, a user terminal 300, and a communication network 400. In the transaction processing system 500, the plurality of store systems 100, the relay server 200, and the user terminal 300 are communicably connected with one another via the communication network 400. FIG. 1 shows two store systems 100. These store systems 100 are respectively provided in different stores A and B using the transaction processing system 500. There may be three or more stores using the transaction processing system 500, and the store system 100 is provided in each store. It should be noted that hereinafter, as it is necessary to distinguish the store system 100 provided in each store, the store system 100 provided in the store A will be referred to as a store system 100-1, and the store system 100 provided in the store B will be referred to as a store system 100-2. The business operator operating the store A may be the same as or different from the business operator operating the store B. Also in a case where the transaction processing system 500 is used in another store, the business operator operating the store may be the same as or different from the business operator operating the store A or the store B.

The relay server 200 relays data communication between the user terminal 300 and the store system 100. The relay server 200 provides, for example, a relay function for data communication as a cloud service via the communication network 400. The user terminal 300 is an information processing apparatus that functions as a user interface for the customer who shops by using the transaction processing system 500 in the store. The user terminal 300 has a function of wirelessly communicating with the store system 100 and a function of wirelessly communicating with the communication network 400. A communication terminal having a data communication function such as a smartphone and a tablet terminal can be used as the user terminal 300. The user terminal 300 may be owned by the customer or may be lent to the customer by the store. For example, one of the Internet, a virtual private network (VPN), a local area network (LAN), a public communication network, a mobile communication network, or the like or an appropriate combination thereof can be used as the communication network 400. The communication network 400 typically uses a mobile communication network and the Internet or the VPN.

The schematic configuration of each store system 100 is common. That is, the store system 100 includes a store server 1, a virtual POS server 2, a mobile controller 3, a communication server 4, a check-out machine 5, and an access point 6, and a store communication network 7. In the store system 100, the store server 1, the virtual POS server 2, the mobile controller 3, the communication server 4, the check-out machine 5, and the access point 6 are communicably connected with one another via the store communication network 7. However, the store server 1, the virtual POS server 2, the mobile controller 3, the communication server 4, the check-out machine 5, the access point 6, and the store communication network 7 only need to have the common functions for realizing operations to be described later and does not need to be completely identical. Some store systems 100 may also include devices that are not shown in FIG. 1.

The store server 1 comprehensively manages a plurality of transactions that has been targets of transaction processing realized by the store systems 100 in a manner to be described later. The store server 1 has, for example, functions similar to those of an existing POS server. The virtual POS server 2 performs information processing for registering purchased commodities for each transaction and paying for the purchased commodities in response to a request from an external device. That is, the virtual POS server 2 virtually realizes functions of an existing POS terminal. The information processing performed by the virtual POS server 2 is customized to accommodate a difference in operation policy of each store. That is, for example, the information processing performed by the store server 1 provided in the store system 100-1 may be partially different from the information processing performed by the store server 1 provided in the store system 100-2.

The mobile controller 3 provides assistance for performing the above-mentioned information processing by the virtual POS server 2 while using the user terminal 300 as a user interface device. The communication server 4 performs communication processing for the store server 1, the virtual POS server 2, the mobile controller 3, and the check-out machine 5 to exchange data with the relay server 200 and the like via the communication network 400.

The check-out machine 5 determines an amount of money for the purchased commodities for each transaction managed by the virtual POS server 2, and performs a process for causing the customer to pay the amount of money. The payment methods that the check-out machine 5 can accept for such payment may be all or some of well-known payment methods such as cash payment, credit card payment, electronic money payment, point payment, and code payment (also called mobile payment, smartphone payment, or the like). The check-out machine 5 may be an apparatus that is operated by either a store employee or a customer. For example, a self-check-out machine used in an existing semi-self-POS system can be used as the check-out machine 5. The check-out machine 5 may have a function of performing information processing for registering a commodity as a purchased commodity. In this case, for example, a face-to-face POS terminal used in an existing POS system or a self-POS terminal used in an existing self-POS system can be used as the check-out machine 5.

The access point 6 performs communication processing for enabling the user terminal 300 to access the store communication network 7 by wireless communication. For example, a well-known communication device that performs wireless communication according to the IEEE802.11 standard can be used as the access point 6. The access point 6 is installed in the store such that the user terminal 300 can perform wireless communication anywhere in the store. Depending on the store size, a plurality of access points 6 may be arranged in one store system 100. For example, one of the Internet, a VPN, a LAN, a public communication network, a mobile communication network, or the like or an appropriate combination thereof can be used as the store communication network 7. Typically, the store communication network 7 is a LAN.

A two-dimensional code TCI for check-in is posted near the entrance of the store provided with the store system 100 and a two-dimensional code TCO for check-out is posted near the exit. The two-dimensional code TCI indicates check-in data for check-in. The two-dimensional code TCO indicates check-out data for check-out. The check-in data and the check-out data differ from store to store. Therefore, in a case where the two-dimensional codes TCI, TCO for the store A need to be distinguished from the two-dimensional codes TCI, TCO for the store B, those for the store A will be referred to as two-dimensional codes TCIA, TCOA and those for the store B will be referred to as two-dimensional codes TCIB, TCOB.

The check-in data includes, for example, the following information (1) to (34).

(1) An operation version of the store system 100. For example, the check-in data indicated by the two-dimensional code TCIA indicates the operation version of the store system 100-1. The check-in data indicated by the two-dimensional code TCIB indicates the operation version of the store system 100-2.

(2) A business operator code for identifying a business operator operating the store in which the store system 100 is provided. For example, the check-in data indicated by the two-dimensional code TCIA indicates the business operator code assigned to the business operator operating store A. The check-in data indicated by the two-dimensional code TCIB indicates the business operator code assigned to the business operator operating the store B.

(3) A store code for identifying the store in which the store system 100 is provided. For example, the check-in data indicated by the two-dimensional code TCIA indicates the store code assigned to store A. The check-in data indicated by the two-dimensional code TCIB indicates the store code assigned to the store B. It should be noted that the store code may be capable of identifying each of all the stores using the transaction processing system 500 or may be capable of identifying each of a plurality of stores operated by the same business operator.

(4) The name of the business operator operating the store in which the store system 100 is provided. For example, the check-in data indicated by the two-dimensional code TCIA indicates the name of the business operator operating the store A. The check-in data indicated by the two-dimensional code TCIB indicates the name of the business operator operating the store B.

(5) The name of the store in which the store system 100 is provided. For example, the check-in data indicated by the two-dimensional code TCIA indicates the name of the store A. The check-in data indicated by the two-dimensional code TCIB indicates the name of the store B.

(6) A flag for distinguishing the two-dimensional code TCI from the two-dimensional code TCO. The flag in the check-in data is put in a state indicating that it is check-in data. The state is, for example, “1”. The flag is common to all the two-dimensional codes TCI.

(7) An IP address of the communication server 4. For example, the check-in data indicated by the two-dimensional code TCIA indicates the IP address of the communication server 4 included in the store system 100-1. The check-in data represented by the two-dimensional code TCIB indicates the IP address of the communication server 4 included in the store system 100-2.

(8) A domain name of the relay server 200. The domain name is common to all the two-dimensional codes TCI. However, a plurality of relay servers 200 having different domain names may be used separately for each store. In this case, the check-in data indicated by the two-dimensional code TCI indicates the domain name of the relay server 200 used in the corresponding store.

(9) The address of the electronic receipt server. The electronic receipt server is not included in the transaction processing system 500 shown in FIG. 1, and provides an electronic receipt service via the communication network 400. For example, the check-in data indicated by the two-dimensional code TCIA indicates an address for accessing the electronic receipt server that provides the electronic receipt service used by the business operator operating the store A via the communication network 400. The check-in data indicated by the two-dimensional code TCIB indicates an address for accessing the electronic receipt server that provides the electronic receipt service used by the business operator operating the store B via the communication network 400. Those addresses may be common to all the two-dimensional codes TCI or any one of a plurality of addresses may be shown for each two-dimensional code TCI.

(10) A flag indicating whether the user terminal 300 should use wireless communication with the access point 6 or wireless communication with the communication network 400 for data exchange with the store system 100. For example, in a case where the wireless communication with the access point 6 is used for data exchange between the store system 100-1 and the user terminal 300 in the store A, the flag is set to “1”, for example. For example, in a case where the wireless communication with the communication network 400 is used for data exchange between the store system 100-2 and the user terminal 300 in the store B, the flag is set to “0”, for example.

(11) A service set identifier (SSID) for identifying the access point 6. For example, the check-in data indicated by the two-dimensional code TCIA indicates the SSID for identifying the access point 6 included in the store system 100-1. The check-in data indicated by the two-dimensional code TCIB indicates the SSID of the access point 6 included in the store system 100-2.

(12) A password for accessing the access point 6. For example, the check-in data indicated by the two-dimensional code TCIA indicates the password set in the access point 6 included in the store system 100-1. The check-in data indicated by the two-dimensional code TCIB indicates the password set in the access point 6 included in the store system 100-2.

(13) An identification number of a security system used by the access point 6. For example, “1” is assigned to a WPA2-PSK system, “2” is assigned to a WPA-PSK system, and “3” is assigned to a WEP system as the identification number. For example, in a case where the access point 6 included in the store system 100-1 uses the WPA2-PSK system as the security system, the check-in data indicated by the two-dimensional code TCIA indicates “1” as the identification number. Further, for example, in a case where the access point 6 included in the store system 100-2 uses the WPA-PSK method as the security system, the check-in data indicated by the two-dimensional code TCIB indicates “2” as the identification number.

(14) A flag for identifying whether to conclude an error when the user terminal 300 fails to connect to the relay server 200 or to continue the operation without concluding an error. For example, in a case where a setting to conclude an error when the user terminal 300 fails to connect to the relay server 200 is employed in the store A, the check-in data indicated by the two-dimensional code TCIA indicates, for example, “1” as the flag. Further, for example, in a case where a setting to continue the operation even in a case where the user terminal 300 fails to connect to the relay server 200 is employed in the store B, the check-in data indicated by the two-dimensional code TCIB indicates, for example, “0” as the flag.

(15) An identification number of a transmission mode related to a status of the user terminal 300. The transmission mode includes, for example, a first mode, a second mode, and a third mode. For example, “1” is assigned to the first mode, “2” is assigned to the second mode, and “3” is assigned to the third mode as the identification number of the transmission mode. On the first mode, the status of the user terminal 300 is transmitted to the relay server 200. On the second mode, the status of the user terminal 300 is transmitted to the store system 100. On the third mode, the status of the user terminal 300 is not transmitted. For example, in a case where the first mode is applied as the transmission mode in the store A, the check-in data indicated by the two-dimensional code TCIA indicates “1” as the ID number. For example, in a case where the second mode is applied as the transmission mode in the store B, the check-in data represented by the two-dimensional code TCIB indicates “2” as the ID number.

(16) An identification number of a transmission mode related to a log file storing log data of the user terminal 300. The transmission mode includes, for example, a first mode, a second mode, a third mode, and a fourth mode. For example, “1” is assigned to the first mode, “2” is assigned to the second mode, “3” is assigned to the third mode, and “4” is assigned to the fourth mode as the identification number of the transmission mode. On the first mode, the log file is transmitted only to the relay server 200. On the second mode, the log file is transmitted only to the store system 100. On the third mode, the log file is transmitted to both the store system 100 and the relay server 200. On the fourth mode, the log file is not transmitted. For example, in a case where the first mode is applied as the transmission mode in the store A, the check-in data indicated by the two-dimensional code TCIA indicates “1” as the ID number. For example, in a case where the second mode is applied as the transmission mode in the store B, the check-in data indicated by the two-dimensional code TCIB indicates “2” as the ID number.

(17) A host name or IP address used when transmitting the log file in accordance with a file transfer protocol (FTP) to the relay server 200 via the communication network 400.

(18) A user name used when transmitting the log file in accordance with the FTP to the relay server 200 via the communication network 400.

(19) A password used when transmitting the log file in accordance with the FTP to the relay server 200 via the communication network 400.

(20) A path name of the log file to be transmitted in accordance with the FTP to the relay server 200 via the communication network 400.

(21) A flag for identifying whether or not to delete check digits of a universal product code (UPC) which is a kind of commodity code. For example, in a case where the operation not to delete the check digits is employed in the store A, the check-in data indicated by the two-dimensional code TCIA indicates, for example, “1” as the flag. Further, for example, in a case where the operation to delete the check digits is employed in the store B, the check-in data indicated by the two-dimensional code TCIB indicates, for example, “0” as the flag.

(22) A time until the camera screen is automatically shift in the user terminal 300. The check-in data indicated by the two-dimensional code TCIA indicates a time preset for the store A as the time. The check-in data indicated by the two-dimensional code TCIB indicates a time preset for the store B as the time.

(23) A timeout time when the user terminal 300 communicates with the store system 100 via the access point 6. The check-in data indicated by the two-dimensional code TCIA indicates a time preset for the store A as the time. The check-in data indicated by the two-dimensional code TCIB indicates a time preset for the store B as the time.

(24) The allowable number of retries when the communication between the user terminal 300 and the store system 100 via the access point 6 times out. The check-in data indicated by the two-dimensional code TCIA indicates the number of retries preset for the store A as the number of retries. The check-in data indicated by the two-dimensional code TCIB indicates the number of retries preset for the store B as the number of retries.

(25) A timeout time when the user terminal 300 communicates with the store system 100 via the relay server 200. The check-in data indicated by the two-dimensional code TCIA indicates a time preset for the store A as the time. The check-in data indicated by the two-dimensional code TCIB indicates a time preset for the store B as the time.

(26) The allowable number of retries when the communication between the user terminal 300 and the store system 100 via the relay server 200 times out. The check-in data indicated by the two-dimensional code TCIA indicates the number of retries preset for the store A as the number of retries. The check-in data indicated by the two-dimensional code TCIB indicates the number of retries preset for the store B as the number of retries.

(27) Authentication data used in a certification process for authenticating a declaration of completion of confirmation related to a transaction with respect to a commodity that requires confirmation by the store employee. The check-in data indicated by the two-dimensional code TCIA indicates the authentication data preset for the store A. The check-in data indicated by the two-dimensional code TCIB indicates the authentication data preset for the store B. The authentication data is favorably determined to be different for each store, but the same authentication data may be set for different stores.

(28) Data for identifying an operation mode of the store system 100. For example, in a case where the store system 100-1 is set to be on a normal mode to normally operate the transaction processing system 500, the check-in data indicated by the two-dimensional code TCIA indicates, for example, “1” as the data. Further, for example, in a case where the store system 100-2 is set to be on a demonstration mode to demonstrate the transaction processing system 500, the check-in data indicated by the two-dimensional code TCIB indicates, for example, “2” as the data.

(29) Data for identifying the mode of data transfer to the check-out machine 5. For example, in a case where the store system 100-1 is set to be on a mode on which the check-out machine 5 requests the mobile controller 3 to transfer data, the check-in data indicated by the two-dimensional code TCIA indicates, for example, “1” as the data. Further, for example, in a case where the store system 100-2 is set to be on a mode on which data is transferred from the mobile controller 3 to the check-out machine 5 without a request from the check-out machine 5, the check-in data indicated by the two-dimensional code TCIB indicates, for example, “2” as the data.

(30) A flag indicating whether or not payment as the code payment through an operation of the user terminal 300 is permitted. For example, in a case where the code payment is permitted in the store A, the check-in data indicated by the two-dimensional code TCIA indicates, for example, “1” as the flag. Further, for example, in a case where the code payment is not permitted in the store B, the check-in data indicated by the two-dimensional code TCIB indicates, for example, “0” as the flag.

(31) A flag for identifying whether or not registration of a product (hereinafter, referred to as age-restricted product) for which the age restriction of a purchaser is defined through the user terminal 300 is permitted. For example, in a case where the registration of the age-restricted product through the user terminal 300 is permitted in the store A, the check-in data indicated by the two-dimensional code TCIA indicates, for example, “1” as the flag. Further, for example, in a case where the registration of the age-restricted product through the user terminal 300 is not permitted in the store B, the check-in data indicated by the two-dimensional code TCIB indicates, for example, “0” as the flag.

(32) Data for identifying an input mode of a membership code of a point member. For example, in a case where the store system 100-1 is set to be on a mode to manually input the membership code, the check-in data indicated by the two-dimensional code TCIA indicates, for example, “1” as the data. Further, for example, in a case where the store system 100-2 is set to be on a mode to input the membership code by reading a barcode, the check-in data indicated by the two-dimensional code TCIB indicates, for example, “2” as the data.

(33) A flag for identifying whether or not confirmation by the store employee is required for inputting the membership code in a case where the mode to manually input the membership code of the point member is set. For example, in a case where the confirmation is required at the store A, the check-in data indicated by the two-dimensional code TCIA indicates, for example, “1” as the flag. Further, for example, in a case where the confirmation is not required in the store B, the check-in data indicated by the two-dimensional code TCIB indicates, for example, “0” as the flag.

(34) A threshold for checking a remaining battery level of the user terminal 300 during check-in. The threshold is set for each store or for each business operator. For example, in a case where the business operator operating the store A sets the threshold to “20%”, the check-in data indicated by the two-dimensional code TCIA indicates, for example, “20” as the threshold. For example, in a case where the store B sets the threshold to “25%”, the check-in data indicated by the two-dimensional code TCIB indicates, for example, “25” as the threshold.

The above is an example of the information indicated by the check-in data. However, the check-in data does not need to include some of the various types of information described above. Further, the check-in data may indicate information different from the various types of information described above.

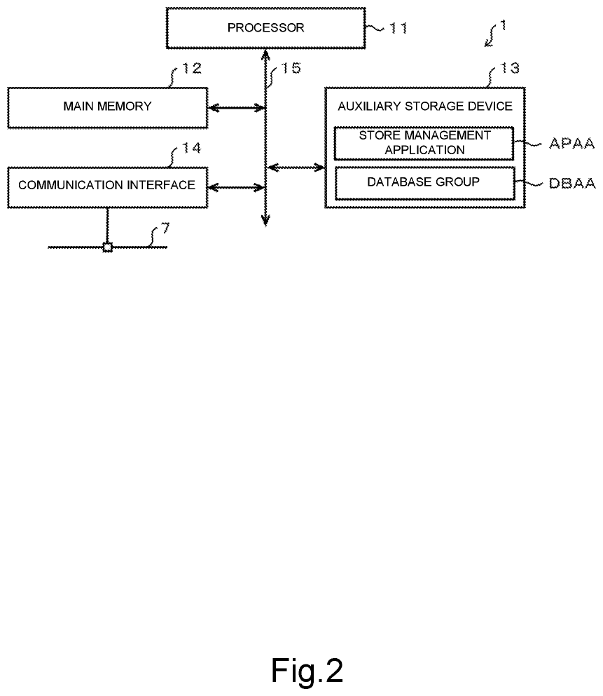

FIG. 2 is a block diagram showing a circuit configuration of the store server 1. The store server 1 includes a processor 11, a main memory 12, an auxiliary storage device 13, a communication interface 14, and a transmission path 15. The processor 11, the main memory 12, the auxiliary storage device 13, and the communication interface 14 are communicably connected with one another via the transmission path 15. The processor 11, the main memory 12, and the auxiliary storage device 13 are connected through the transmission path 15 to configure a computer for controlling the store server 1.

The processor 11 corresponds to a central portion of the computer. The processor 11 performs information processing for realizing various functions as the store server 1 in accordance with information processing programs such as an operating system and an application program. The processor 11 is, for example, a central processing unit (CPU).

The main memory 12 corresponds to a main storage portion of the computer. The main memory 12 includes a non-volatile memory area and a volatile memory area. The main memory 12 stores the above-mentioned information processing programs in the non-volatile memory area. The main memory 12 may store data necessary for the processor 11 to perform the information processing in the non-volatile or volatile memory area. The main memory 12 uses the volatile memory area as a work area in which data is rewritten by the processor 11 as appropriate. The non-volatile memory area is, for example, a read only memory (ROM). The volatile memory area is, for example, a random access memory (RAM).

The auxiliary storage device 13 corresponds to an auxiliary storage portion of the computer. For example, a well-known storage device such as an electric erasable programmable read-only memory (EEPROM), a hard disc drive (HDD), and a solid state drive (SSD) can be used as the auxiliary storage device 13. The auxiliary storage device 13 stores data used by the processor 11 to perform various processes, data generated by processing in the processor 11, and the like. The auxiliary storage device 13 may store the information processing programs.

The communication interface 14 performs data communication with each unit connected to the store communication network 7 in accordance with a predetermined communication protocol. For example, a well-known communication device for the LAN can be applied as the communication interface 14. The transmission path 15 includes an address bus, a data bus, a control signal line, and the like, and transmits data and control signals exchanged between the connected units.

The auxiliary storage device 13 stores a store management application APAA which is one of the information processing programs. The store management application APAA is an application program and describes the information processing for realizing the functions as the store server 1. The store management application APAA may be a separate one generated in accordance with the store management policy of each store or each business operator operating the store. For example, in a case where the method of managing sales data differs between the store A and the store B, the store management application APAA used in the store system 100-1 describes information processing for management of the sales data conforming to the method of managing the sales data in the store A. The store management application APAA used in the store system 100-2 describes information processing for management of sales data conforming to the method of managing the sales data in the store B.

A portion of the storage area of the auxiliary storage device 13 is used as a database group DBAA. The database group DBAA includes a plurality of databases for various types of information management. One of the databases included in the database group DBAA is a commodity database for managing commodities sold in the store. A commodity database is a set of data records associated with commodities to be managed. The data record of the commodity database includes data related to the associated commodity, such as a commodity code, a price, and a commodity name. The commodity code is an identifier set for identifying commodities for each stock keeping unit (SKU), and, for example, a Japanese article number (JAN) code is used. The commodity name is a name set such that a person can easily distinguish the commodity from the others. The price is an amount of money for purchasing the commodity.

One of the databases included in the database group DBAA is a user database for managing store users. The user database is a set of data records associated with customers registered as the users. The data record of the user database includes data related to the associated customer, such as a user code and attribute information for identifying the user. The user code is a unique identification code set for each customer in order to individually identify the user. The attribute information may include name, gender, age, address, telephone number, and the like. The data record in the user database may also include payment information declared by the user. The payment information includes a credit number, a code payment identifier (ID), and the like. Further, in a case where a plurality of payment methods can be selected, the payment information includes a payment method code for identifying the payment method. Further, in the case of a store offering a point (reward) service, the payment information includes a point service ID, held points, and the like.

In addition, the database group DBAA may include a variety of databases like those managed by a POS server in the existing POS system. It should be noted that what type of database the database group DBAA includes or what type of data those databases include may be determined for each store.

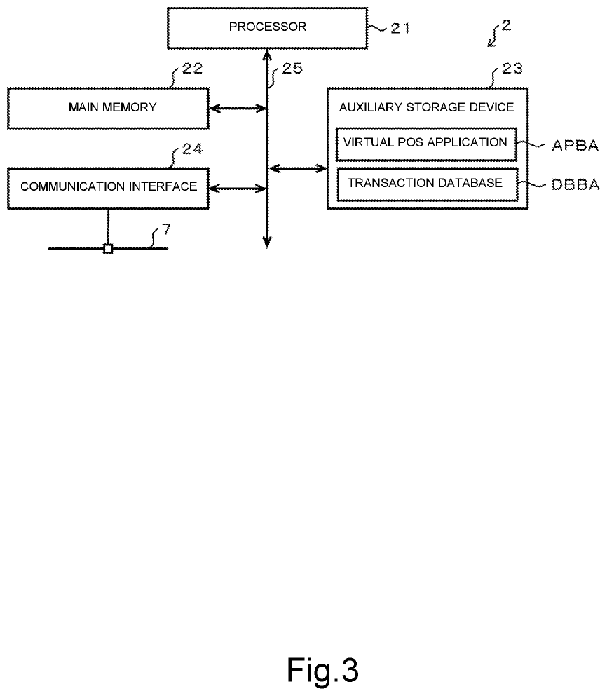

FIG. 3 is a block diagram showing a circuit configuration of the virtual POS server 2. The virtual POS server 2 includes a processor 21, a main memory 22, an auxiliary storage device 23, a communication interface 24, and a transmission path 25. The processor 21, the main memory 22, the auxiliary storage device 23, and the communication interface 24 are communicably connected with one another via the transmission path 25. The processor 21, the main memory 22, and the auxiliary storage device 23 are connected through the transmission path 25 to configure a computer for controlling the virtual POS server 2. It should be noted that schematic functions of the processor 21, the main memory 22, the auxiliary storage device 23, the communication interface 24, and the transmission path 25 is similar to those of the processor 11, the main memory 12, the auxiliary storage device 13, the communication interface 14, and the transmission path 15, and thus descriptions thereof will be omitted.

It should be noted that the auxiliary storage device 23 stores a virtual POS application APBA instead of the store management application APAA. The virtual POS application APBA is an application program and describes information processing for realizing the function as the virtual POS server 2. The virtual POS application APBA may be a separate one generated in accordance with the store management policy of each store or each business operator operating the store. For example, in a case where the store A offers a discount service that is not offered by the store B, the virtual POS application APBA used in the store system 100-1 describes information processing for realizing the discount service, and the virtual POS application APBA used in the store system 100-2 does not describe information processing for realizing the discount service.

Further, a portion of the storage area of the auxiliary storage device 23 is used as a transaction database DBBA instead of the database group DBAA. The transaction database DBBA are is a set of data records associated with transactions with customers shopping in the store. The data record of the transaction database DBBA includes a transaction code and commodity data related to a commodity registered as a purchased commodity. The transaction code is a unique identification code set for each transaction for identifying each transaction. The commodity data indicates a commodity code, a commodity name, a price, the number of commodities (quantity), and the like. The structure of the transaction database DBBA may be individually determined in accordance with the store management policy of each store or each business operator operating the store.

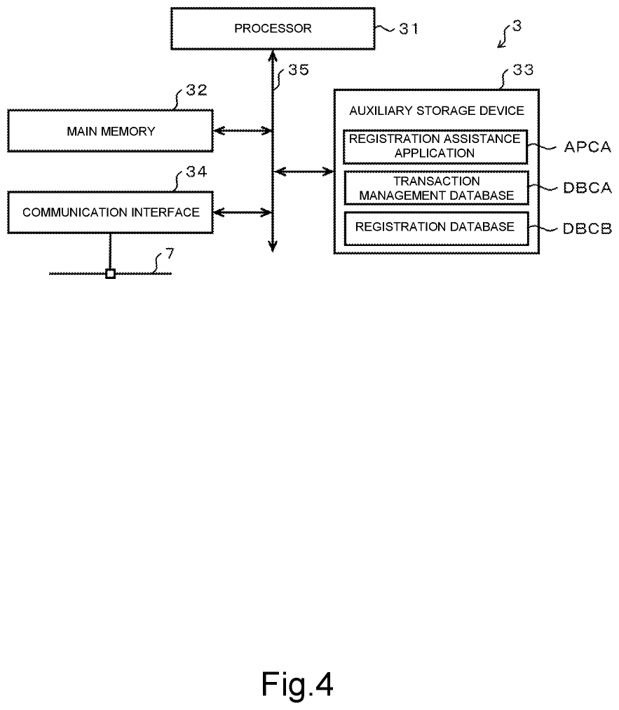

FIG. 4 is a block diagram showing a circuit configuration of the mobile controller 3. The mobile controller 3 includes a processor 31, a main memory 32, an auxiliary storage device 33, a communication interface 34, and a transmission path 35. The processor 31, the main memory 32, the auxiliary storage device 33, and the communication interface 34 are communicably connected with one another via a transmission path 35. The processor 31, the main memory 32, and the auxiliary storage device 33 are connected through the transmission path 35 to configure a computer for controlling the mobile controller 3. It should be noted that schematic functions of the processor 31, the main memory 32, the auxiliary storage device 33, the communication interface 34, and the transmission path 35 are similar to those of the processor 11, the main memory 12, the auxiliary storage device 13, the communication interface 14, and the transmission path 15, and thus descriptions thereof will be omitted.

It should be noted that the auxiliary storage device 33 stores a registration assistance application APCA instead of the store management application APAA. The registration assistance application APCA is an application program and describes information processing to be described later for assisting registration of a purchased commodity. The registration assistance application APCA is common to the respective store systems 100. However, various settings for information processing based on the registration assistance application APCA may be customized for each store system 100.

Further, a portion of the storage area of the auxiliary storage device 23 is used as a transaction management database DBCA and a registration database DBCB instead of the database group DBAA. The structures of the transaction management database DBCA and the registration database DBCB are common to the respective store systems 100.

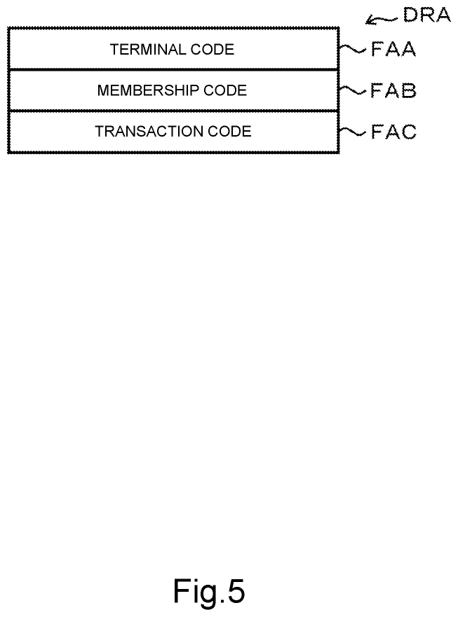

FIG. 5 is a diagram schematically showing a data structure of a data record DRA included in the transaction management database DBCA. The transaction management database DBCA is a set of data records DRA associated with the user terminal 300 used by customers in the store. Therefore, when there is only one customer in the store, the transaction management database DBCA includes one data record DRA. When there are no customers in the store, the transaction management database DBCA includes no data records DRA. The data record DRA includes fields FAA, FAB, FAC, and FAD as shown in FIG. 5.

The field FAA is set with a terminal code in order to identify the associated user terminal 300. For example, a unique identification code set for each communication terminal in order to identify each communication terminal used as the user terminal 300 or the cart terminal 400 can be used as the terminal code. Alternatively, for example, an identification code set for a smartphone POS application or cart terminal application to be described later when installing the smartphone POS application or cart terminal application in the user terminal 300 can be used as the terminal code. The field FAB is set with a membership code for identifying the customer using the associated user terminal 300 from other customers. The field FAC is set with the transaction code of a transaction performed by using the associated user terminal 300.

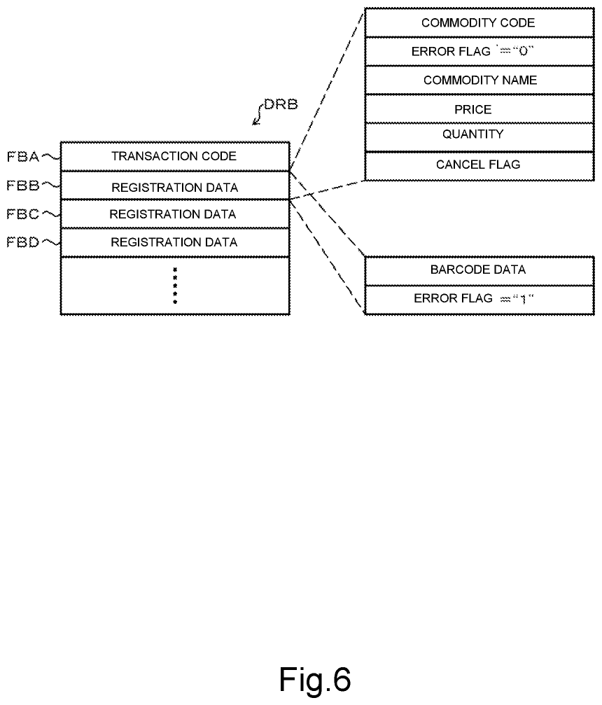

FIG. 6 is a diagram schematically showing a data structure of a data record DRB included in the registration database DBCB. The registration database DBCB is a set of data records DRB associated with transactions with customers shopping in the store. The data record DRB includes fields FBA and FBB as shown in FIG. 6. The data record DRA can further include fields FBC, FBD, . . . .

The field FBA shown in FIG. 6 is set with the transaction code of the associated transaction. The transaction code is identical to the transaction code set in field FAB of the data record DRA (see FIG. 5) associated with the user terminal 300 used in the associated transaction. The field FBB is set with registration data for commodity registration attempted for the associated transaction. The registration data will be described later. The data record DRB includes fields subsequent to the field FBC in a case where two or more purchased commodities are attempted to be registered for the associated transaction. Registration data similar to that of the field FAB is set in the fields subsequent to the field FBC.

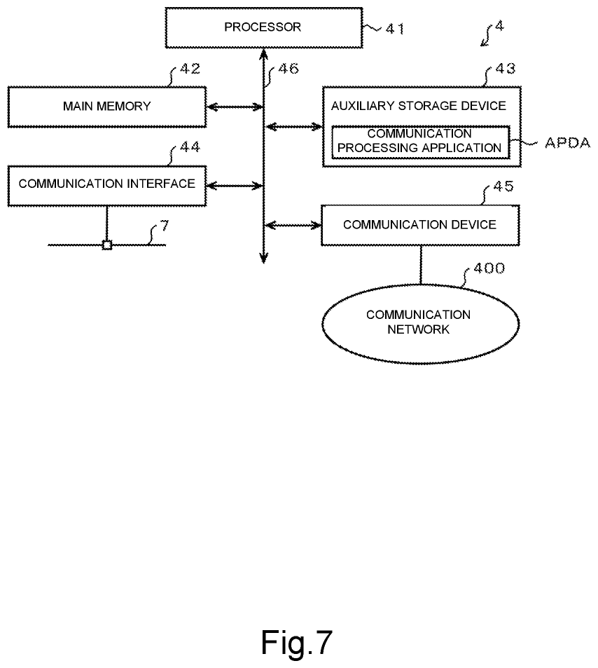

FIG. 7 is a block diagram showing a circuit configuration of the communication server 4. The communication server 4 includes a processor 41, a main memory 42, an auxiliary storage device 43, a communication interface 44, a communication device 45, and a transmission path 46. The processor 41, the main memory 42, the auxiliary storage device 43, the communication interface 44, and the communication device 45 are communicably connected with one another via the transmission path 46. The processor 41, the main memory 42, and the auxiliary storage device 43 are connected through the transmission path 46 to configure a computer for controlling the communication server 4. It should be noted that schematic functions of the processor 41, the main memory 42, the auxiliary storage device 43, the communication interface 44, and the transmission path 46 are similar to those of the processor 11, the main memory 12, the auxiliary storage device 13, the communication interface 14, and the transmission path 15, and thus descriptions thereof will be omitted. The communication device 45 performs communication processing for data communication via the communication network 400. For example, a well-known Internet connection device can be applied as the communication device 45.

The auxiliary storage device 43 stores a communication processing application APDA instead of the store management application APAA. The communication processing application APDA is an application program and describes information processing for communication with the relay server 200 via the communication network 400 in order to enable data exchange between the mobile controller 3 and the user terminal 300 to be performed. The communication processing application APDA is common to each store system 100. It should be noted that various settings for information processing based on the communication processing application APDA may be customized for each store system 100.

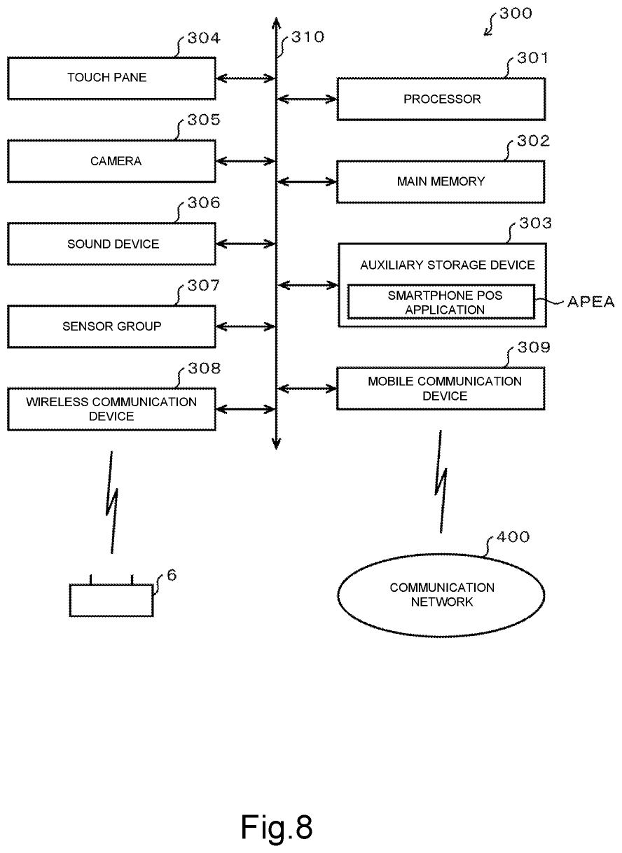

FIG. 8 is a block diagram showing a circuit configuration of the user terminal 300. The user terminal 300 includes a processor 301, a main memory 302, an auxiliary storage device 303, a touch panel 304, a camera 305, a sound device 306, a sensor group 307, a wireless communication device 308, a mobile communication device 309, a transmission path 310, and the like. The processor 301, the main memory 302, the auxiliary storage device 303, the touch panel 304, the camera 305, the sound device 306, the sensor group 307, the wireless communication device 308, and the mobile communication device 309 are communicably connected with one another via the transmission path 310. Then, the processor 301, the main memory 302, and the auxiliary storage device 303 are connected through the transmission path 310 to configure a computer for controlling the user terminal 300. It should be noted that schematic functions of the processor 11, the main memory 12, the auxiliary storage device 13, and the transmission path 15 are similar to those of the processor 11, the main memory 12, the auxiliary storage device 13, and the transmission path 15, and thus descriptions thereof will be omitted.

The touch panel 304 functions as an input device and a display device of the user terminal 300. The camera 305 includes an optical system and an image sensor and generates image data representing an image in a field of view formed by the optical system through the image sensor. The sound device 306 outputs various sounds such as voice and melody. The sensor group 307 includes various sensors such as an angular velocity sensor and a global positioning system (GPS) sensor.

The wireless communication device 308 exchanges data with the access point 6 through wireless communication according to a wireless communication protocol. For example, a well-known communication device according to the IEEE802.11 standard can be used as the wireless communication device 308. The mobile communication device 309 is an interface of data communication via the communication network 400. A well-known communication device for performing data communication via a mobile communication network can be used as the mobile communication device 309, for example.

It should be noted that the auxiliary storage device 303 stores a smartphone POS application APEA that is one of information processing programs. The smartphone POS application APEA is an application program and describes information processing to be described later for making the user terminal 300 function as a user interface of the store system 100. The smartphone POS application APEA is commonly used among a plurality of user terminals 300.

For example, a general-purpose server device can be used as a hardware of the store server 1, the virtual POS server 2, or the mobile controller 3. The store server 1, the virtual POS server 2, or the mobile controller 3 is generally transferred in a state in which the store management application APAA, the virtual POS application APBA, or the registration assistance application APCA is stored in the auxiliary storage device 13, 23, or 33, and the database group DBAA, the transaction database DBBA, or the transaction management database DBCA and the registration database DBCB are not stored. However, hardware in a state in which the store management application APAA, the virtual POS application APBA, or the registration assistance application APCA is not stored in the auxiliary storage device 13, 23, or or in a state in which the same type of application program in another version is stored in the auxiliary storage device 13, 23, or 33 and the store management application APAA, the virtual POS application APBA, or the registration assistance application APCA may be individually transferred. The store server 1, the virtual POS server 2, or the mobile controller 3 may be configured by writing the store management application APAA, the virtual POS application APBA, or the registration assistance application APCA in the auxiliary storage device 13, 23, or 33 in accordance with an operation of an arbitrary operator. The store management application APAA, the virtual POS application APBA, or the registration assistance application APCA can be transferred by recording on a removable recording medium such as a magnetic disk, a magneto-optical disc, an optical disc, and a semiconductor memory or by communication via a network. The transaction database DBBA, or the transaction management database DBCA, and the registration database DBCB are configured in the auxiliary storage device 13, 23, or 33 by the processor 11, 21, or 31 performing information processing based on the store management application APAA, the virtual POS application APBA, or the registration assistance application APCA. It should be noted that at least part of the store management application APAA and the databases included in the database group DBAA may be stored in the main memory 12. At least part of the virtual POS application APBA and the transaction database DBBA may be stored in the main memory 22. At least part of the registration assistance application APCA, the transaction management database DBCA, and the registration database DBCB may be stored in the main memory 32.

Next, an operation of the transaction processing system configured in the above-mentioned manner will be described. It should be noted that the various processes described below are only examples, and it is possible to change the order of some processes, omit some processes, or add other processes as appropriate. For example, descriptions of some processes will be omitted hereinafter for the sake of easy understanding of characteristic operations according to the embodiment. For example, in a case where an error occurs, a process for coping with the error may be performed, but a description of part of such a process will be omitted. It should be noted that a service offered to the customer by the operation of the transaction processing system to be described below will be referred to as a smartphone POS service.

The user terminal 300 exchanges data with the store system 100 in order to use the smartphone POS service. Whether the wireless communication with the access point 6 and the wireless communication with the communication network 400 are used for such communication depends on the state of the flag included in the check-in data. However, for the sake of simplicity of description, a case where only the wireless communication with the access point 6 is used will be described hereinafter. Which mode of the mode on which the check-out machine 5 requests the mobile controller 3 to transfer data and the mode on which data is transferred from the mobile controller 3 to the check-out machine 5 without a request from the check-out machine 5 is to be used for data transfer from the virtual POS server 2 to the check-out machine 5 for performing check-out through the check-out machine 5 depends on the state of the flag included in the check-in data. However, for the sake of simplicity of description, the description will be given hereinafter, assuming that the mode on which the check-out machine 5 requests the mobile controller 3 to transfer data is constantly used.

In order to use the smartphone POS service, the customer installs the smartphone POS application APEA in the smartphone or the like owned by the customer and makes the smartphone or the like usable as the user terminal 300. Alternatively, the customer rents the user terminal 300 configured by installing the smartphone POS application APEA into a tablet terminal or the like at the store. Then, the customer enters any store in which the store system 100 is provided with the user terminal 300 in which the information processing based on the smartphone POS application APEA is activated.

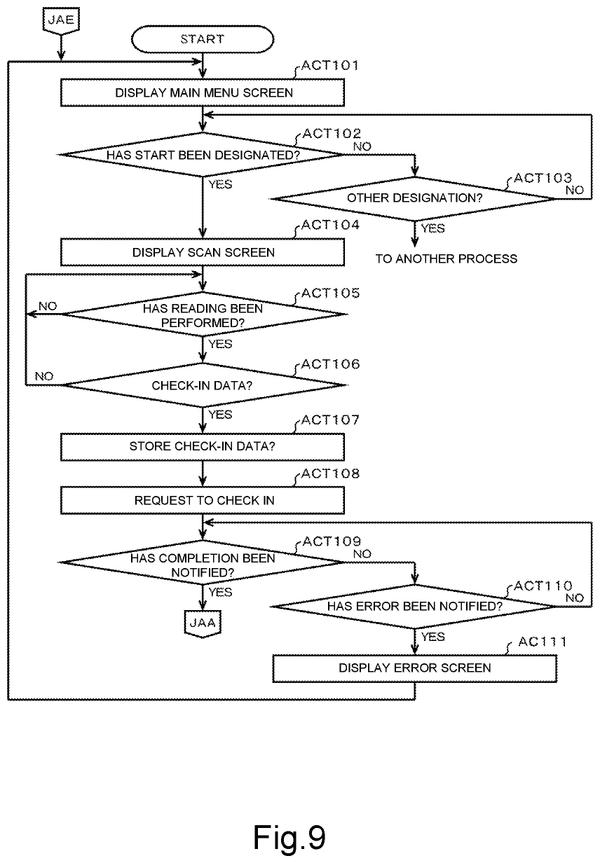

In the user terminal 300, the processor 301 performs the information processing shown in FIGS. 9, 10, 11, 12, and 13 on the basis of the smartphone POS application APEA. First, in ACT101 shown in FIG. 9, the processor 301 displays a main menu screen on the touch panel 304. The main menu screen is a screen for receiving designation of any of several types of processes to be performed on the basis of the smartphone POS application APEA. The main menu screen includes a plurality of GUI (graphical user interface) elements, including a GUI element for designating the shopping start. It should be noted that the GUI element is, for example, a soft key.

In ACT102, the processor 301 determines whether or not the shopping start has been designated. In a case where the processor 301 determines that the shopping start has not been designated, i.e., in a case where the processor 301 cannot confirm the designation of the shopping start (NO in ACT102), the processing of the processor 301 proceeds to ACT103. In ACT103, the processor 301 determines whether or not designation other than designation of the shopping start has been made. In a case where the processor 301 determines that the designation other than designation of the shopping start has not been made, i.e., in a case where the processor 301 cannot confirm designation other than the designation of the shopping start (NO in ACT103), the processing of the processor 301 returns to ACT102. The processor 301 thus waits for some designation on the main menu screen to be made in ACT102 and ACT103. In a case where it is determined that the designation other than the designation of the shopping start has been made (YES in ACT103), the processing of the processor 301 proceeds to the designated process. It should be noted that a description of the processing of the processor 301 in this case will be omitted. The processing of the processor 301 for registering the electronic receipt ID or the point ID described above may form part of the process here.

When the customer enters the store and starts shopping, the customer performs a predetermined operation for designating the shopping start on the main menu screen. When the operation for designating the shopping start is detected by the touch panel 304 for example, the processor 301 determines that the shopping start has been designated (YES in ACT102). Then, the processing of the processor 301 proceeds to ACT104. In ACT104, the processor 301 displays a scan screen for check-in on the touch panel 304. The scan screen for check-in is a screen for prompting the customer to read the two-dimensional code TCI for check-in. The processor 301, for example, activates the camera 305 and generates the scan screen by superimposing a character message prompting the customer to read the two-dimensional code TCI and a line indicating a position to which the two-dimensional code TCI should be made to face on the image thus obtained by the camera 305.

When the scan screen is displayed on the touch panel 304, the customer directs the camera 305 to the two-dimensional code TCI such that the two-dimensional code TCI posted near the entrance of the store is reflected on the scan screen. In ACT105, the processor 301 waits for the two-dimensional code to be read while determining whether or not the two-dimensional code has been read. At this time, the processor 301 repeatedly analyzes the image obtained by the camera 305 and attempts to read the two-dimensional code. The reading of the two-dimensional code may be performed as a process based on the smartphone POS application APEA or may be read as a process based on another application program for reading the two-dimensional code. In a case where it is determined that the two-dimensional code has been read (YES in ACT105), the processing of the processor 301 proceeds to ACT106.

In ACT106, the processor 301 determines whether or not data indicated by the read two-dimensional code is the check-in data. In a case where it is determined that the data is not the check-in data (NO in ACT106), the processing of the processor 301 returns to ACT105. At this time, the processor 301 may cause the touch panel 304 to display a screen for notifying the customer that an erroneous two-dimensional code has been read.

In a case where it is determined that the data represented by the read two-dimensional code is the check-in data (YES in ACT106), the processing of the processor 301 proceeds to ACT107. In ACT107, the processor 301 stores the read check-in data in the main memory 302 or in the auxiliary storage device 303.

In ACT108, the processor 301 requests the mobile controller 3 to check in. Specifically, the processor 301 establishes wireless communication between the wireless communication device 308 and the access point 6 on the basis of the data represented by the check-in data. For example, when the camera 305 is directed by the customer to the two-dimensional code TCIA in the store A, the processor 301 establishes wireless communication with the access point 6 provided in the store system 100-1 on the basis of the check-in data indicated by the two-dimensional code TCIA. The processor 301 transmits request data for requesting check-in to the mobile controller 3 by wireless communication with the access point 6. When the wireless communication with the access point 6 provided in the store system 100-1 is established as described above, the request data is transmitted to the mobile controller 3 provided in the store system 100-1 via the access point 6 and the store communication network 7 provided in the store system 100-1. It should be noted that the processor 301 includes identification data for identifying the check-in request and a terminal code in the request data for requesting check-in. In a case where the customer is a registered user of the smartphone POS service and has the membership code, the processor 301 also includes the membership code in the request data. The membership code is stored in the auxiliary storage device 43 of the user terminal 300, for example. The processor 301 may include other data in the request data such as data for authenticating the customer, for example. It should be noted that various requests from the user terminal 300 to the mobile controller 3 to be described later are realized by transmitting request data including identification data for identifying the type of request from the user terminal 300 to the mobile controller 3 via the access point 6 and the store communication network 7 as described above.

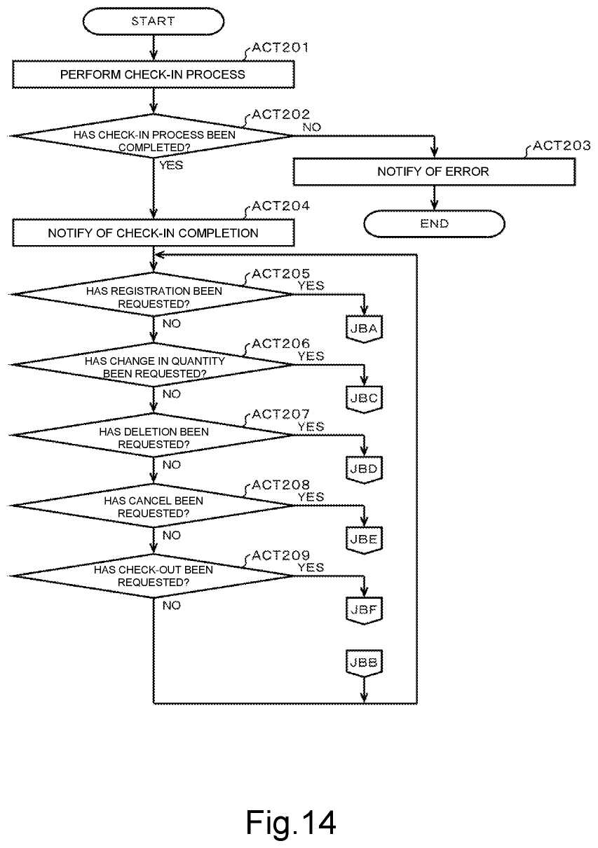

In the mobile controller 3, when the request data for requesting check-in is received by the communication interface 34, the processor 31 starts information processing related to a transaction with the customer who attempts to check in. FIGS. 14, 15, 16, and 17 are flowcharts of information processing by the processor 31. Every time request data for requesting check-in is received by the communication interface 34, the processor 31 starts the information processing. When the processor 31 is performing information processing started on the basis of another request, the processor 31 starts new information processing concurrently with the information processing. That is, the processor 31 may perform a plurality of types of information processing concurrently for the plurality of user terminals 300. Hereinafter, when the “user terminal 300” is simply shown, it refers to the user terminal 300 to be subjected to the information processing of the processor 31.

In ACT201 of FIG. 14, the processor 31 performs a check-in process. For example, the processor 31 requests the virtual POS server 2 to start a transaction and receives a notification of the transaction code. Then, the processor 31 adds a new data record DRA with the terminal code included in the request data set in the field FAA (see FIG. 5) to the transaction management database DBCA. In a case where the request data includes a membership code, the processor 31 sets the membership code in the field FAB of the new data record DRA. The processor 31 sets the transaction code notified from the virtual POS server 2 in the field FAC of the new data record DRA. Accordingly, the management of the transaction performed by using the user terminal 300 that has requested check-in is started. It should be noted that in the virtual POS server 2, the processor 21 determines a transaction code in accordance with a predetermined rule and starts registration processing of the purchased commodity in association with the transaction code in a case where the transaction start has been requested from the mobile controller 3. Further, the processor 21 notifies the determined transaction code of the mobile controller 3.

In ACT202 shown in FIG. 14, the processor 31 determines whether or not the check-in process has been successfully completed. Then, in a case where it is determined that the check-in process has not been successfully completed, i.e., in a case where the check-in process has not been successfully completed because of some abnormality (NO in ACT202), the processing of the processor 31 proceeds to ACT203. In ACT203, the processor 31 notifies the user terminal 300 of the error. The processor 31 transmits, for example, notification data for error notification to the user terminal 300 via the store communication network 7 and the access point 6. The processor 31 includes identification data in the notification data for identifying the error notification. The processor 31 may include an error code for indicating the cause of the error in the notification data. It should be noted that various notifications from the mobile controller 3 to the user terminal 300 such below are realized by transmitting notification data including identification data for identifying the type of notification from the mobile controller 3 to the user terminal 300 via the store communication network 7 and the access point 6 as in the above.

On the other hand, in a case where it is determined that the check-in process has been successfully completed (YES in ACT202), the processing of the processor 31 proceeds to ACT204. In ACT204, the processor 31 notifies the user terminal 300 of the check-in completion. The processor 31 transmits notification data for notification of the check-in completion to the user terminal 300 via the store communication network 7 and the access point 6, for example. The processor 31 includes identification data for identifying the notification of the check-in completion in the notification data.

In the user terminal 300, the processing of the processor 301 proceeds to ACT109 after requesting the check-in in ACT108 of FIG. 9. In ACT109, the processor 301 determines whether or not the check-in completion has been notified. Then, in a case where it is determined that the check-in completion has not been notified, i.e., in a case where the notification of the check-in completion cannot be confirmed (NO in ACT109), the processing of the processor 301 proceeds to ACT110. In ACT110, the processor 301 determines whether or not a check-in error has been notified. In a case where it is determined that the check-in error has not been notified, i.e., in a case where the notification of the check-in error cannot be confirmed (NO in ACT110), the processing of the processor 301 returns to ACT109. As described above, the processor 301 waits for a check-in completion or error to be notified in ACT109 and ACT110. In a case where notification data for such an error notification is received by the wireless communication device 308, the processor 301 determines that a check-in error has been notified (YES in ACT110). After that, the processing of the processor proceeds to ACT111.

In ACT111, the processor 301 causes the touch panel 304 to display an error screen. The error screen is a screen for notifying the customer that the check-in is impossible. When an instruction to cancel the display of the error screen is made by operating the GUI element or the like displayed on the error screen, for example, the processing of the processor 301 returns to ACT101.

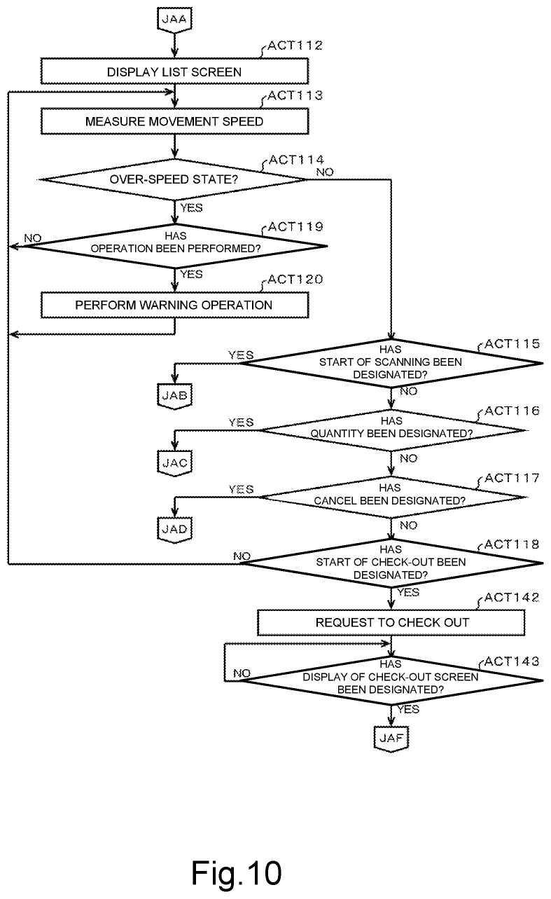

On the other hand, in a case where it is determined that the check-in completion has been notified, i.e., in a case where the notification data for notification of the check-in completion has been received by the wireless communication device 308 (YES in ACT109), the processing of the processor 301 proceeds to ACT112 of FIG. 10. It should be noted that at this time, it is clear that the user terminal 300 is present inside the store. That is, at this time, the processor 301 detects that the operator using the user terminal 300 is present inside the store that is an example of a predetermined area. By the processor 301 performing the information processing based on the smartphone POS application APEA as described above, the computer having the processor 301 as its central part functions as a first detection means. In ACT112 of FIG. 10, the processor 301 causes the touch panel 304 to display a list screen. The list screen is a screen on which a list of registered purchased commodities is displayed.

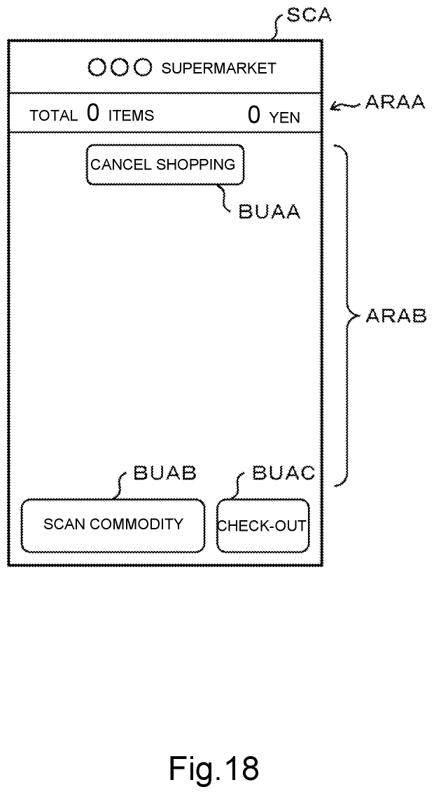

FIG. 18 is a diagram showing an example of a list screen SCA displayed on the touch panel 304 of the user terminal 300. The list screen SCA includes display areas ARAA and ARAB and button BUAA, BUAB, and BUAC as shown in FIG. 18. The display area ARAA displays the total number of purchased commodities and the total amount of money for the purchased commodities. The display area ARAB displays a list of purchased commodities. The button BUAA is a soft key for the customer to declare that the customer cancels all the purchased commodities and also cancels the shopping. The button BUAB is a soft key for the customer to declare that the customer starts scanning the commodities to be registered as the purchased commodities. The button BUAC is a soft key for the customer to declare that the customer starts check-out.

It should be noted that FIG. 18 shows the list screen SCA in a state in which the purchased commodities have not yet been registered. Therefore, “0” is displayed as both the total number and the total amount of money on the display area ARAA and nothing is displayed on the display area ARAB.

In ACT113 of FIG. 10, the processor 301 measures movement speed of the customer operating the user terminal 300. The processor 301 measures, for example, the movement speed of the customer as movement speed of the user terminal 300. The processor 301 measures the movement speed of the user terminal 300 by well-known processing on the basis of a change in angular velocity measured by the angular velocity sensor included in the sensor group 307, for example. Alternatively, the processor 301 measures the movement speed of the user terminal 300 by well-known processing on the basis of a change in position measured by the GPS sensor included in the sensor group 307.

In ACT114, the processor 301 determines whether or not the movement speed of the user terminal 300 is an over-speed state. The processor 301 determines, for example, whether or not the measured movement speed is equal to or higher than a predetermined threshold value. In a case where the movement speed of the user terminal 300 is lower than the threshold value, the processor 301 determines that the movement speed of the user terminal 300 is not the over-speed state (NO in ACT114). The processing of the processor 301 then proceeds to ACT115. It should be noted that the processor 301 may apply other processing such as determining whether or not the movement speed of the user terminal 300 is equal to or lower than the threshold value in ACT114 and determining that the movement speed of the user terminal 300 is not the over-speed state in a case where the movement speed is equal to or lower than the threshold value. The threshold value may be arbitrarily set by a creator of the smartphone POS application APEA, for example. The threshold value may be arbitrarily set by a store administrator and included in the check-in data. It should be noted that the threshold value should be determined such that it can be determined that the over-speed state is achieved when the customer is substantially moving. Thus, in a case where the processor 301 determines that the movement speed of the user terminal 300 is in the over-speed state (YES in ACT114), the processor 301 detects the movement of the customer who is the operator. Thus, by the processor 301 performing the information processing based on the smartphone POS application APEA, the computer having the processor 301 as its central part functions as a second detection means.

In ACT115 of FIG. 10, the processor 301 of the user terminal 300 determines whether or not the start of scanning the commodities has been designated. In a case where it is determined that the start of scanning the commodities has not been designated, i.e., in a case where the designation of the start of scanning the commodities cannot be confirmed (NO in ACT115), the processing of the processor 301 proceeds to ACT116. In ACT116, the processor 301 determines whether or not a change in quantity has been designated. In a case where it is determined that the change in quantity has not been designated, i.e., in a case where the designation of the change in quantity cannot be confirmed (NO in ACT116), the processing of the processor 301 proceeds to ACT117. In ACT117, the processor 301 determines whether or not cancel of the shopping has been designated. In a case where it is determined that the cancel of the shopping has not been designated, i.e., in a case where the designation of the cancel of the shopping cannot be confirmed (NO in ACT117), the processing of the processor 301 proceeds to ACT118. In ACT118, the processor 301 determines whether or not the start of the check-out has been designated. In a case where it is determined that the start of the check-out has not been designated, i.e., in a case where the designation of the start of the check-out cannot be confirmed (NO in ACT118), the processing of the processor 301 returns to ACT113. As described above, in a case where the over-speed state is not achieved, the processor 301 waits for either the scan start, the change in quantity, the cancel, or the check-out start to be designated in ACT115 to ACT118.

On the other hand, in a case where the movement speed of the user terminal 300 is equal to or higher than the threshold value, it is determined that the user terminal 300 is in the over-speed state (YES in ACT114), and the processing of the processor 301 proceeds to ACT119. In ACT119, the processor 301 determines whether or not a certain operation has been performed. In a case where it is determined that no operations have been performed, i.e., in a case where no operations can be confirmed (NO in ACT119), the processing of the processor 301 returns to ACT113. That is, when the movement speed of the user terminal 300 is in the over-speed state, the processor 301 repeats the determination in ACT119 and waits for a certain operation to be performed. In a case where it is determined that a certain operation has been performed in this state (YES in ACT119), the processing of the processor 301 proceeds to ACT120. That is, for example, in a case where the customer performs an operation for designating either the scan start, the change in quantity, the cancel, or the check-out start while moving at the movement speed equal to or higher than the threshold value, the processing of the processor 301 proceeds to ACT120.

In ACT120, the processor 301 performs a warning operation. The warning operation is a predetermined operation to warn the customer that the operation cannot be performed during the movement. The processor 301 drives the sound device 306 to output a predetermined voice message, for example. The output of the voice message is suitable for the warning here, since it can audibly warn the customer. Instead of or in addition to outputting the voice message, the processor 301 may perform an operation such as outputting an alarm sound through the sound device 306, displaying a warning screen on the touch panel 304, or lighting a lamp (not shown) as the warning operation. It should be noted that in many cases, the customer sees the display on the touch panel 304 for operation. Therefore, the display on the touch panel 304 or the like also becomes an effective alarm. When the warning operation is completed, the processor 301 repeats the processing in ACT113 and the subsequent steps in a manner similar to that described above.

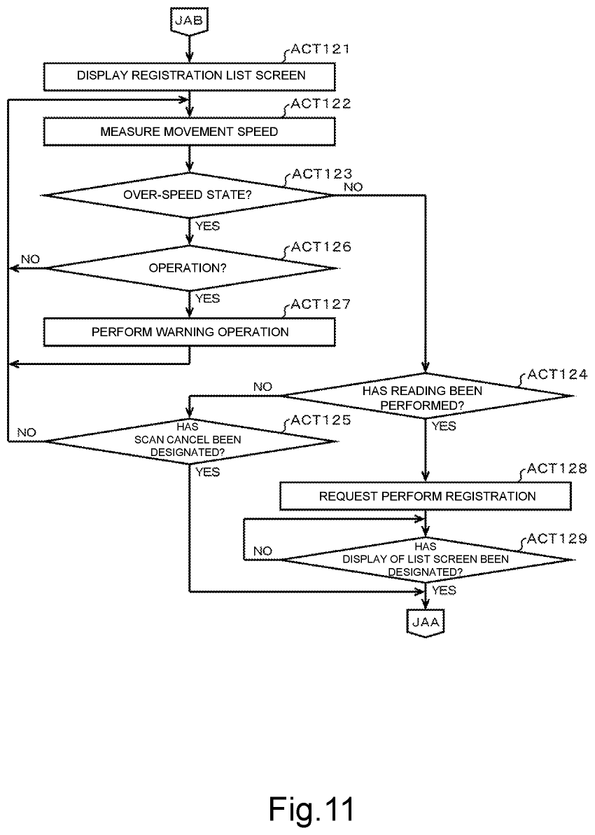

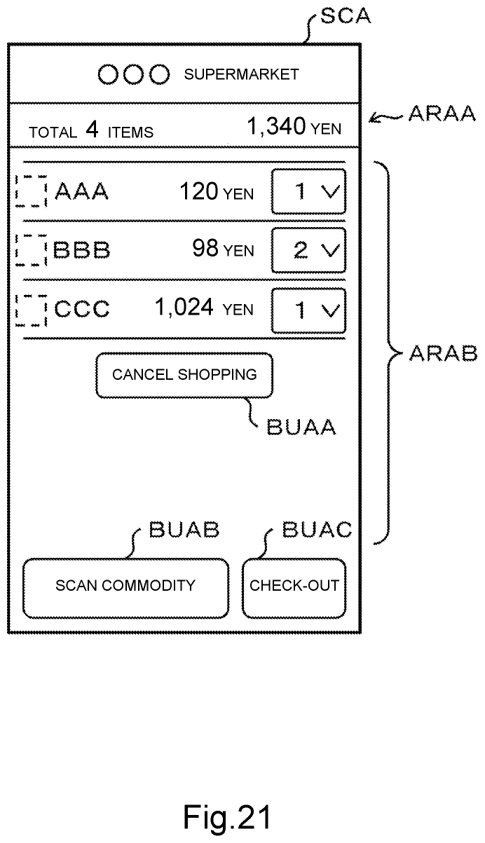

When registering the commodities as the purchased commodities, the customer designates the start of scanning by a predetermined operation such as touching the button BUAB on the list screen SCA (see FIG. 18 or 21). In response to it, the processor 301 determines that the start of scanning the commodities has been designated (YES in ACT115). Then, the processing of the processor 301 proceeds to ACT121 of FIG. 11. In ACT121, the processor 301 causes the touch panel 304 to display a registration screen. The registration screen is a screen for prompting the customer to read barcodes representing the commodity codes of commodities to be registered as purchased commodities.

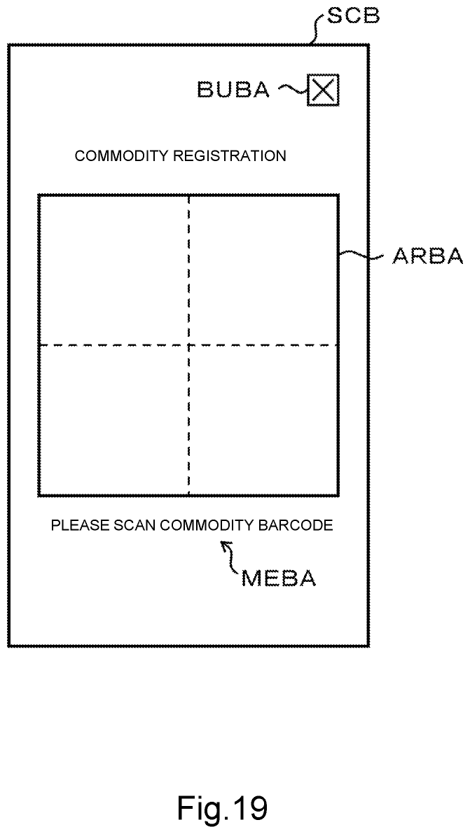

FIG. 19 is a diagram showing an exemplary registration screen SCB. The registration screen SCB includes a display area ARBA, a message MEBA, and a button BUBA. The display area ARBA displays an image obtained by the camera 305. The message MEBA is a character message that prompts the customer to read the barcodes of the commodities. The button BUBA is a soft key for the customer to declare that the customer cancels the scanning of the commodity codes. For example, the processor 301 activates the camera 305 and generates the registration screen SCB by superimposing an image showing a line indicating the range of the display area ARBA and the message MEBA and the button BUBA on the image thus obtained by the camera 305.

In ACT122 of FIG. 11, the processor 301 measures the movement speed of the customer operating the user terminal 300 in a manner similar to that in ACT113 of FIG. 10, for example. However, in ACT122, the processor 301 may perform processing different from the processing of ACT113. In ACT123, the processor 301 determines whether or not the movement speed of the user terminal 300 is in the over-time state, in a manner similar to that in the processing of ACT114 of FIG. 10, for example. However, in ACT123, the processor 301 may perform processing different from the processing of ACT114. In a case where the movement speed of the user terminal 300 is lower than the threshold value, the processor 301 determines that the movement speed of the user terminal 300 is not in the over-speed state (NO in ACT123). The processing of the processor 301 then proceeds to ACT124.

In ACT124 of FIG. 11, the processor 301 of the user terminal 300 determines whether or not the barcode has been read. At this time, the processor 301 analyzes the image obtained by the camera 305 and attempts to read the barcode. The barcode reading may be read as a process based on the smartphone POS application APEA or as a process based on another application program for reading the barcode. In a case where it is determined that the barcode cannot be read, i.e., in a case where the barcode cannot be read (NO in ACT124), the processing of the processor 301 proceeds to ACT125. In ACT125, the processor 301 determines whether or not scan cancel has been designated. In a case where it is determined that the scan cancel has not been designated, i.e., in a case where the designation of the scan cancel cannot be confirmed (NO in ACT125), the processing of the processor 301 returns to ACT122. In a case where the movement speed of the user terminal 300 is not in the over-speed state, the processor 301 waits for the barcode to be read or the scan cancel to be designated in ACT124 and ACT125 as described above.

On the other hand, in a case where the movement speed of the user terminal 300 is equal to or higher than the threshold value, it is determined that the movement speed of the user terminal 300 is in the over-speed state (YES in ACT123), and the processing of the processor 301 proceeds to ACT126. In ACT126, the processor 301 determines whether or not a certain operation has been performed. In a case where it is determined that no operations have been performed, i.e., no operations can be confirmed (NO in ACT126), the processing of the processor 301 returns to ACT122. In other words, when the movement speed of the user terminal 300 is in the over-speed state, the processor 301 repeats the determination in ACT126 and waits for a certain operation to be performed. In a case where it is determined that the certain operation has been performed in this state (YES in ACT126), the processing of the processor 301 proceeds to ACT127. That is, in a case where the customer performs an operation for reading a barcode or an operation for designating scan cancel while moving at a movement speed equal to or higher than the threshold value, for example, the processing of the processor proceeds to ACT127. In ACT127, the processor 301 performs the warning operation in a manner similar to that of the processing of ACT120 of FIG. 10, for example. Thus, the processor 301 performs information processing based on the smartphone POS application APEA, such that the computer having the processor 301 as its central part functions as a warning unit. However, in ACT123, the processor 301 may perform processing different from the processing of ACT114. When the warning operation is completed, the processor 301 repeats the processing in ACT122 and the subsequent steps in a manner similar to that described above.

When the customer wishes to return to the list screen from the registration screen without performing the current scan, the customer designates the scan cancel by a predetermined operation such as touching the button BUBA. In response to it, the processor 301 determines that the scan cancel has been designated (YES in ACT125). Then, the processing of the processor 301 returns to ACT112 of FIG. 10.

When the registration screen is displayed on the touch panel 304, the customer directs the camera 305 to the commodity such that the barcode displayed on the commodity to be registered as the purchased commodity is reflected on the display area ARBA in a state in which the customer is not moving. In response to it, the processor 301 determines that the barcode has been read (YES in ACT124). Then, the processing of the processor 301 proceeds to ACT128. In ACT128, the processor 301 requests the mobile controller 3 of the registration. The processor 301 includes data (hereinafter, referred to as barcode data) indicated by the read barcode in the request data transmitted here. At this time, the processor 301 obtains the commodity code included in the barcode. The commodity code is an example of an identifier. Then, the processor 301 determines the commodity code obtained when the customer who is the operator is present inside the store, which is the predetermined area, and the movement of the operator is not detected, as the identifier for identifying the commodity that is the transaction target. Thus, when the processor 301 performs the information processing based on the smartphone POS application APEA, the computer having the processor 301 as its central part functions as an obtaining means and a determination means.

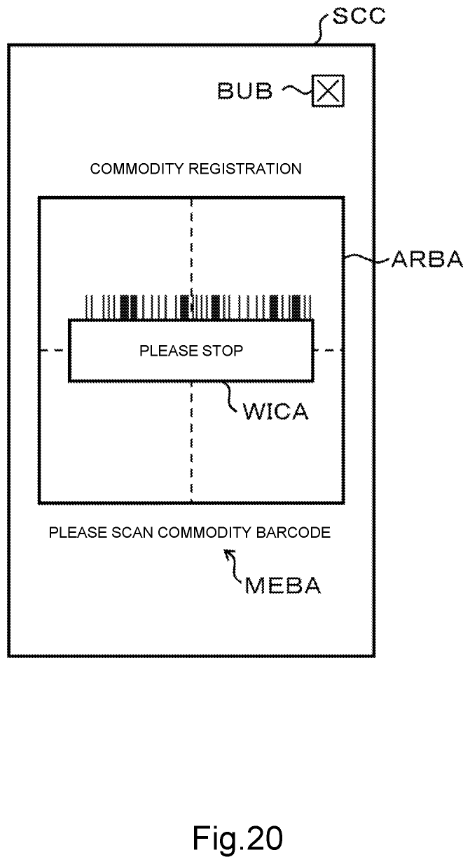

By the way, in a case where the processor 301 determines that a certain operation has been performed as described above (YES in ACT126), the operation of the customer as the trigger is the operation of reading the barcode as described above, and in many cases, the customer is viewing the display of the touch panel 304. Therefore, although warning using the voice message similar to the processing in ACT120 is effective, it is also effective to display the warning screen. FIG. 20 is a diagram showing an example of a warning screen SCC. The warning screen SCC is a screen displayed in the display area ARBA, on which a window WICA is superimposed on the registration screen SCB showing a barcode. The window WICA is a text message that prompts the customer to stop moving.

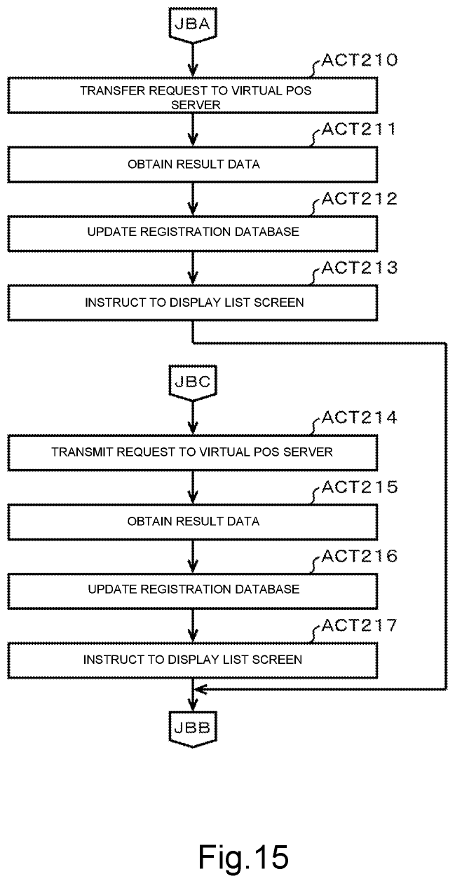

In the mobile controller 3, the processing of processor proceeds to ACT205 after notification of the check-in completion in ACT204 of FIG. 14. In ACT205, the processor 31 determines whether or not registration has been requested. In a case where it is determined that the registration has not been requested, i.e., in a case where the registration request cannot be confirmed (NO in ACT205), the processing of the processor 31 proceeds to ACT206. In ACT206, the processor 31 determines whether a change in quantity has been requested. In a case where it is determined that the change in quantity has not been requested, i.e., in a case where the request for changing the quantity cannot be confirmed (NO in ACT206), the processing of the processor 31 proceeds to ACT207. In ACT207, the processor 31 determines whether or not deletion of the purchased commodity has been requested. In a case where it is determined that the deletion of the purchased commodity has not been requested, i.e., in a case where the deletion request of the purchased commodity cannot be confirmed (NO in ACT207), the processing of the processor proceeds to ACT208. In ACT208, the processor 31 determines whether or not cancel of the purchased commodity has been requested. In a case where the processor 31 determines that the cancel of the purchased commodity has been not requested, i.e., in a case where the request for cancelling the purchased commodity cannot be confirmed (NO in ACT208), the processing of the processor 31 proceeds to ACT209. In ACT209, the processor 31 determines whether or not check-out has been requested. In a case where it is determined that the check-out has not been requested, i.e., in a case where the check-out has not been requested (NO in ACT209), the processing of the processor 31 returns to ACT205. The processor 31 thus waits for either the registration, the change in quantity, the deletion of the purchased commodity, the cancel of the purchased commodity, or the check-out to be requested in ACT205 or ACT209. In a case where it is determined that the registration has been requested from the user terminal 300 as described above, i.e., in a case where the registration has been requested from the user terminal 300 (YES in ACT205), the processing of the processor 31 proceeds to ACT210 of FIG. 15.

In ACT210 of FIG. 15, the processor 31 transmits the request of registration to the virtual POS server 2 with a notification of the transaction code of the transaction to be processed. At this time, the processor 31 may transfer the request data transmitted from the user terminal 300 as it is to the virtual POS server 2 or may transmit the request data converted by a certain process to the virtual POS server 2. However, the processor 31 notifies the virtual POS server 2 of the barcode data or the identification data included in the request data transmitted from the user terminal 300.

In the virtual POS server 2, the processor 21 determines that the barcode data included in the request data has been read by a barcode scanner provided in the existing POS terminal and attempts to register the purchased commodity by a process similar to that of the existing POS terminal. However, the commodity code indicated by the barcode data may not be registered in the commodity database due to a certain cause. Or, a barcode different from the barcode indicating the commodity code may be displayed on the commodity. In such a case, the processor 21 cannot register the purchased commodity and considers it as an error. In this manner, the processor 21 registers the purchased commodity on the basis of reading of the barcode indicating the commodity code registered in the commodity database. The processor 21 manages the purchased commodities by using the transaction database DBBA.

The processor 21 transmits result data indicating the result of the above-mentioned process to the mobile controller 3. When the registration of the purchased commodity is correctly performed, the processor 21 includes identification data for identifying the normal registration notification, and the commodity code, the commodity name, and the price of the registered commodity in the result data. In a case of considering the registration of the purchased commodity as the error, the processor 21 includes the identification data for identifying the error notification and the barcode data transmitted in the registration request in the result data.

In the mobile controller 3, the processing of the processor 31 proceeds to ACT211 after transferring the registration request in ACT210. In ACT211 of FIG. 15, the processor 31 obtains the result data transmitted from the virtual POS server 2 in the above-mentioned manner. The processor 31 stores the obtained result data in the main memory 32 or the auxiliary storage device 33.

In ACT212 of FIG. 15, the processor 31 updates the registration database DBCB on the basis of the result data. The registration database DBCB is updated as follows, for example.

First case: a case where it is the normal registration notification and the registration data including the notified commodity code is not included in the data record DRB associated with the transaction to be processed. In this case, the processor 31 adds a new field subsequent to the last field that already exists in the data record DRB associated with the transaction to be processed and adds new registration data to that field. The processor 31 includes, in the new registration data, the notified commodity code, an error flag set as “0” indicating that it is not an error, the notified commodity name and price, the quantity set as “1”, and a cancel flag set as “0” indicating that it has not been canceled. The registration data thus added in this case has a structure as shown on the upper right side of FIG. 6.

Second case: a case where it is the normal registration notification and the registration data including the notified commodity code is included in the data record DRB associated with the transaction to be processed but the cancel flag of the registration data is “1” indicating that the cancel flag of the registration data has been canceled. In this case, the processor 31 performs processing similar to that in the first case described above.

Third case: a case where it is the normal registration notification, the registration data including the notified commodity code is included in the data record DRB associated with the transaction to be processed, and the cancel flag of the registration data is “0”. In this case, the processor 31 rewrites the value of the quantity included in the registration data including the notified commodity code and having the cancel flag set as “0” to a value that is one more than that value.

Fourth case: a case where it is the notification of the error. In this case, the processor 31 adds a new field subsequent to the last field that already exists in the data record DRB associated with the transaction to be processed and adds new registration data to that field. The processor includes, in the new registration data, the notified barcode data and an error flag of “1” indicating an error. The registration data thus added in this case has a structure as shown on the lower right side of FIG. 6.

By being updated by the processor 31 in this manner, the registration database DBCB becomes one indicating a list of purchased commodities registered in the virtual POS server 2 and recording barcode reading resulting in an error in addition to the list. It should be noted that the processor stores the barcode data transmitted in the registration request data in the main memory 32 or the auxiliary storage device 33. The processor 31 may include the stored barcode data in the registration data in the fourth case described above. In this case, in the virtual POS server 2, the processor 21 does not need to include the barcode data in the result data. Alternatively, the processor 31 may extract the commodity code from the stored barcode data and perform the process shown in the first to third cases on the basis of that commodity code. Additionally, the processor 31 may obtains from the store server 1 or the like on the basis of the commodity code.

In ACT213 of FIG. 15, the processor 31 instructs the user terminal 300 to display a list screen (see FIG. 18 or 21). The processor 31 transmits, for example, instruction data including identification data for identifying the instruction of the display of the list screen to the user terminal 300 via the store communication network 7 and the access point 6. The processor 31 includes, in the instruction data, the commodity code, the commodity name, the price, and the quantity included in the data record DRB associated with the transaction to be processed in the registration database DBCB. Further, in a case where the current registration is determined as an error, the processor includes error data indicating this fact in the instruction data. Thereafter, the processing of the processor 31 returns to the standby state of ACT205 to ACT209 of FIG. 14. It should be noted that various instructions from the mobile controller 3 to the user terminal 300 to be described later are realized by transmitting instruction data including identification data for identifying the type of instruction from the mobile controller 3 to the user terminal 300 via the store communication network 7 and the access point 6 as in the above.

In the user terminal 300, the processing of the processor 301 proceeds to ACT129 after requesting the registration in ACT128 of FIG. 11. In ACT129, the processor 301 waits for the display of the list screen to be instructed while determining whether or not the mobile controller 3 has instructed to display the list screen. Then, in a case where it is determined that the mobile controller 3 has instructed to display the list screen in this manner (YES in ACT129), the processing of the processor 301 returns to ACT112 of FIG. 10. Then, the processor 301 causes the touch panel 304 to display the list screen SCA again. At this time, the processor 301 causes the list screen SCA to display the commodity name, the price, and the number of commodities of the purchased commodity included in the instruction data.

FIG. 21 is a diagram showing an exemplary list screen SCA in a state in which the purchased commodities have already been registered. The list screen SCA shown in FIG. 21 is an example in a case where one commodity whose the commodity name is “AAA” and whose price is 120 yen, two commodities whose commodity name is “BBB” and whose price is 98 yen for each, and one commodity whose commodity name is “CCC” and whose price is 1,024 yen have been registered as the purchased commodities. The list screen SCA shown in FIG. 21 displays the names, prices, and quantity of those registered commodities in the display area ARAB. Further, “4” is displayed as the total number and “1,340” is displayed as the total amount of money in the display area ARAA. It should be noted that the area surrounded by the dashed line on the left-hand side of the commodity name is an area for displaying an icon. The dashed line representing that area is not actually displayed on the list screen SCA.

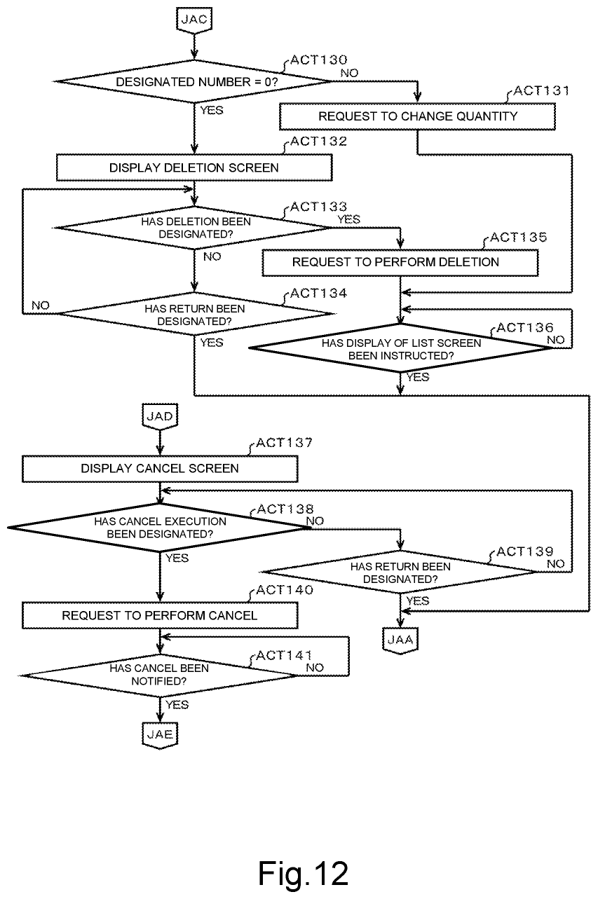

When the customer touches an area displaying the number of commodities on the list screen SCA, the processor 301 displays a list box for designating the number of commodities on the list screen SCA. When this list box is operated, the processor 301 receives it as number designation. In a case where it is determined that the change of the quantity has been designated (YES in ACT116 of FIG. 10), the processing of the processor 301 proceeds to ACT130 of FIG. 12.

In ACT130 of FIG. 12, the processor 301 determines whether or not the designated number is 0. In a case where it is determined that the designated number is not 0 (NO in ACT130), the processing of the processor 301 proceeds to ACT131. In ACT131, the processor 301 requests the mobile controller 3 to change the quantity. The processor 301 includes identification data for identifying the commodity for which the number of commodities has been designated and the designated number in the request data transmitted here. The identification data may be a commodity code or may be data with which the purchased commodity can be designated only by the mobile controller 3, such as a number for identifying each purchased commodity in a list of purchased commodities. In a case where the commodity code is used as the identification code, the processor 31 includes the commodity code for each purchased commodity in the instruction data for instructing to display the list screen.

In the mobile controller 3, the processing of the processor 31 proceeds to ACT214 of FIG. 15 in a case where the change in quantity has been requested from the user terminal 300 as described above, i.e., in a case where the change in quantity has been requested from the user terminal 300 (YES in ACT206 of FIG. 14). In ACT214, the processor 31 transmits a request for changing the quantity to the virtual POS server 2 with a notification of the transaction code of the transaction to be processed. At this time, the processor 31 may transfer the request data transmitted from the user terminal 300 as it is to the virtual POS server 2 or may transmit the request data converted by a certain process to the virtual POS server 2. However, the processor 31 notifies the virtual POS server 2 of the number included in the request data transmitted from the user terminal 300. In a case where the identification data contained in the request data is not the commodity code, the processor 31 replaces the identification data with the commodity code.

In the virtual POS server 2, the processor 21 considers that the number included in the request data transmitted from the mobile controller 3 is input by the input device provided in the existing POS terminal, and changes the number of purchased commodities by processing similar to that of the existing POS terminal. The processor 21 transmits result data representing the commodity code of the commodity for which the number of commodities has been changed and the changed number to the mobile controller 3.

The processing of the processor 31 in the mobile controller 3 proceeds to ACT215 after transferring a request for changing the quantity in ACT214. In ACT215 of FIG. 15, the processor 31 obtains the result data transmitted from the virtual POS server 2 as described above. The processor 31 stores the obtained result data in the main memory 32 or the auxiliary storage device 33.

In ACT216 of FIG. 15, the processor 31 updates the registration database DBCB on the basis of the result data. That is, the processor 31 finds the registration data including the notified commodity code from the data record DRB associated with the transaction to be processed. The processor 31 rewrites the number included in the corresponding registration data to the number included in the result data.

The processor 31 may store the identification data and the number of commodities transmitted in the request data of the change in quantity in the main memory 32 or the auxiliary storage device 33, and rewrite the number of the registration data related to the commodity designated by the stored identification data to the stored number in response to receiving the result data indicating that the update has been completed. In this case, the processor 21 does not need to include the commodity code and the number of commodities in the result data in the virtual POS server 2.

In ACT217, the processor 31 instructs the user terminal 300 to display a list screen. The processor 31 includes, in the instruction data, the commodity code, the commodity name, the price, and the number of commodities included in the registration data in which the cancel flag is “0” among the registration data included in the data record DRB updated as described above. After that, the processing of the processor 31 returns to the standby state of ACT205 to ACT209 in FIG. 14.

In the user terminal 300, the processing of the processor 301 proceeds to ACT132 in a case where it is determined that the designated number is 0 (YES in ACT130 of FIG. 12). In ACT132, the processor 301 causes the touch panel 304 to display a deletion screen. The deletion screen is a screen for notifying the customer that the commodity the number of commodities of which is designated to be 0 is deleted from the purchased commodities. The deletion screen includes a deletion button for designating deletion and a return button for designating return to the state before designating the change of the number of commodities without changing the number of commodities.

In ACT133, the processor 301 determines and confirms whether or not the deletion has been designated. In a case where it is determined that the deletion has not been designated (NO in ACT133), the processing of the processor 301 proceeds to ACT134. In ACT134, the processor 301 determines whether or not the return has been designated. In a case where it is determined that the return has not been designated (NO in ACT134), the processing of the processor 301 returns to ACT133. As described above, the processor 301 waits for the deletion or the return to be designated in ACT133 and ACT134.

In a case where the customer wishes to cancel the deletion and returns to the state before designating the change of the number of commodities, the customer designates the return by a predetermined operation such as touching the return button on the cancel screen. In response to it, the processor 301 determines that the return has been designated (YES in ACT134). Then, the processing of the processor 301 returns to ACT112 of FIG. 10 and the processor 301 causes the touch panel 304 to display the list screen SCA again. In this case, since the registration state of the purchased commodity is not changed, the processor 301 causes the touch panel 304 to display again the list screen SCA in the same state as that displayed before displaying the deletion screen.

In a case where the customer is sure to perform the deletion, the customer designates the deletion by a predetermined operation such as touching the deletion button on the deletion screen. In response to it, the processor 301 determines that the deletion has been designated (YES in ACT133). Then, the processing of the processor 301 proceeds to ACT135. In ACT135, the processor 301 requests the mobile controller 3 to perform the deletion. The processor 301 includes identification data for identifying the commodity the deletion of which has been designated in the request data transmitted here.

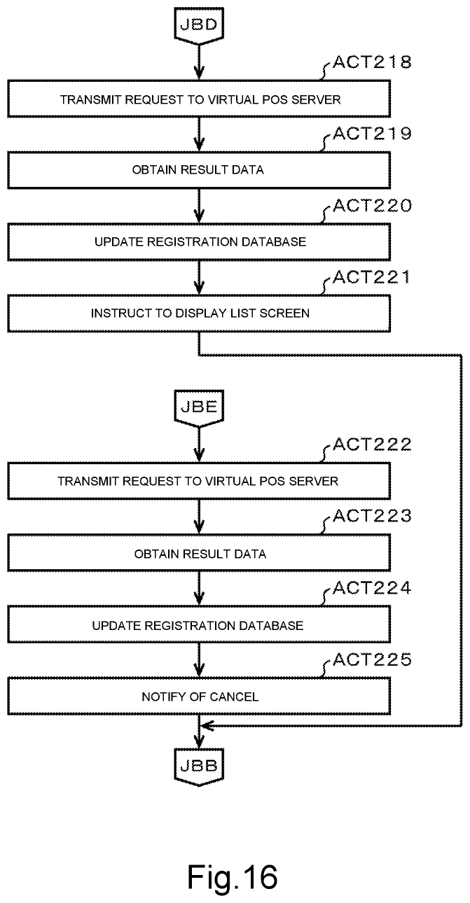

In a case where it is determined that the deletion has been requested from the user terminal 300 as described above (YES in ACT207 of FIG. 14), the processing of the processor 31 in the mobile controller 3 proceeds to ACT218 of FIG. 16. In ACT218, the processor 31 transmits the deletion request to the virtual POS server 2 with a notification of the transaction code of the transaction to be processed. At this time, the processor 31 may transfer the request data transmitted from the user terminal 300 as it is to the virtual POS server 2 or may transmit the request data converted by a certain process to the virtual POS server 2. It should be noted that in a case where the identification data included in the request data is not the commodity code, the processor 31 replaces the identification data by the commodity code.

In the virtual POS server 2, the processor 21 determines that the request based on the request data transmitted from the mobile controller 3 is a deletion instruction input by the input device provided in the existing POS terminal and removes the commodity as the target from the purchased commodities by processing similar to that of the existing POS terminal. The processor 21 transmits result data indicating the commodity code of the commodity removed from the purchased commodities, to the mobile controller 3.

In the mobile controller 3, the processing of the processor 31 proceeds to ACT219 after transferring the deletion request in ACT218. In ACT219 of FIG. 16, the processor 31 obtains the result data transmitted from the virtual POS server 2 in the above-mentioned manner. The processor 31 stores the obtained result data in the main memory 32 or the auxiliary storage device 33.

In ACT220 of FIG. 16, the processor 31 updates the registration database DBCB on the basis of the result data. That is, the processor 31 finds the registration data including the notified commodity code from the data record DRB associated with the transaction to be processed. Then, the processor 31 changes the cancel flag included in the registration data to “1”.

The processor 31 may store the identification data transmitted in the request data for deletion in the main memory 32 or the auxiliary storage device 33, and change the cancel flag of the registration data related to the commodity designated by the stored identification data in response to receiving the result data indicating that the deletion has been completed. In this case, the processor 21 does not need to include the commodity code in the result data in the virtual POS server 2.

In ACT221 of FIG. 16, the processor 31 instructs the user terminal 300 to display a list screen. The processor 31 includes, in the instruction data, the commodity code, the commodity name, the price, and the number of commodities included in the registration data in which the cancel flag is “0” among the registration data included in the data record DRB updated as described above. After that, the processing of the processor 31 returns to the standby state of ACT205 to ACT209 in FIG. 14.

In the user terminal 300, the processing of the processor 301 proceeds to ACT136 after requesting the change in quantity in ACT131 of FIG. 12 or after requesting the deletion in ACT135. In ACT136 of FIG. 12, the processor 301 waits for the display of the list screen to be instructed. In a case where it is determined that the display of the list screen is instructed by the mobile controller 3 in response to the request for changing the quantity or in response to the request for deleting the list screen as described above (YES in ACT136), the processing of the processor 301 returns to ACT112 of FIG. 10. Then, the processor 301 causes the touch panel 304 to display the list screen SCA again. At this time, the processor 301 displays the commodity name, the price, and the number of commodities of the purchased commodity included in the instruction data on the list screen SCA. In this case, since the registration state of the purchased commodity is changed, the processor 301 causes the touch panel 304 to display a list screen SCA indicating a state of the purchased commodity which is different from the state displayed when the change in quantity or deletion is designated.

In a case where the customer wishes to cancel all of the already registered purchased commodities and cancel the shopping, the customer designates the cancel by a predetermined operation such as touching the button BUAA on the list screen SCA. In response to it, the processor 301 determines that the cancel of the shopping has been designated (YES in ACT117 of FIG. 10). The processing of the processor 301 then proceeds to ACT137 of FIG. 12. In ACT137, the processor 301 displays a cancel screen on the touch panel 304. The cancel screen is a screen for notifying the customer that all of the already registered purchased commodities are canceled. The cancel screen includes an execution button for designating cancel execution and a return button for designating return to the state before designating the change of the number of commodities without changing the number of commodities.

In ACT138 of FIG. 12, the processor 301 determines whether or not the cancel execution has been designated. In a case where it is determined that the cancel execution has not been designated, i.e., in a case where the designation of the cancel execution cannot be confirmed (NO in ACT138), the processing of the processor 301 proceeds to ACT139. In ACT139, the processor 301 determines whether or not the return has been designated. In a case where it is determined that the return has not been designated, i.e., in a case where the designation of the return cannot be confirmed (NO in ACT139), the processing of the processor 301 returns to ACT138. Thus, the processor 301 waits for cancel execution or return to be designated in ACT138 and ACT139.

In a case where the customer still continues shopping, the customer designates the return by a predetermined operation such as touching the return button on the cancel screen. In response to it, the processor 301 determines that the return has been designated (YES in ACT139). The processing of the processor 301 returns to ACT112 of FIG. 10, and the processor 301 displays the list screen SCA on the touch panel 304. In this case, since the registration state of the purchased commodity is not changed, the processor 301 causes the touch panel 304 to display again the list screen SCA in the same state as that displayed before displaying the cancel screen.

In a case where the shopping is cancelled, the customer designates cancel execution by a predetermined operation such as touching the execution button on the cancel screen. In response to it, the processor 301 determines that the cancel execution has been designated (YES in ACT138). The processing of the processor 301 then proceeds to ACT140. In ACT140, the processor 301 requests the cancel from the mobile controller 3.

In a case where the mobile controller 3 determines that the cancel has been requested from the user terminal 300 as described above, i.e., in a case where the cancel has been requested from the user terminal 300 (YES in ACT208 of FIG. 14), the processing of the processor 31 proceeds to ACT222 of FIG. 16. In ACT222, the processor 31 transmits the cancel request to the virtual POS server 2 with a notification of the transaction code of the transaction to be processed. At this time, the processor 31 may transfer the request data transmitted from the user terminal 300 as it is to the virtual POS server 2 or may transmit the request data converted by a certain process to the virtual POS server 2.

In the virtual POS server 2, the processor 21 considers that the request based on the request data transmitted from the mobile controller 3 is a cancel instruction input by the input device provided in the existing POS terminal, and removes all the commodities registered in association with the notified transaction code from the purchased commodities by processing similar to that of the existing POS terminal. The processor 21 transmits result data indicating that the cancel has been completed to the mobile controller 3.

The processing of the processor 31 in the mobile controller 3 proceeds to ACT223 after transferring the deletion request in ACT222. In ACT223 of FIG. 16, the processor 31 obtains the result data transmitted from the virtual POS server as described above. The processor 31 stores the obtained result data in the main memory 32 or the auxiliary storage device 33.

In ACT224 of FIG. 16, the processor 31 of the mobile controller 3 updates the registration database DBCB on the basis of the result data. That is, the processor 31 changes the cancel flag set as “0” to “1” for all the pieces of registration data included in the data record DRB associated with the transaction to be processed. In ACT225, the processor 31 notifies the user terminal 300 of the cancel. After that, the processing of the processor 31 returns to the standby state of ACT205 to ACT209 in FIG. 14.

In the user terminal 300, the processor 301 proceeds to ACT141 after requesting the cancel in ACT140 of FIG. 12. In ACT141, the processor 301 waits for the cancel to be notified from the mobile controller 3 while determining whether or not the cancel has been notified from the mobile controller 3. In a case where it is determined that the cancel has been notified from the mobile controller 3, i.e., in a case where the cancel has been notified as described above (YES in ACT141), the processing of the processor 301 returns to ACT101 of FIG. 9.

When the customer has registered all of the commodities wished to be purchased as the purchased commodities, the customer proceeds to payment. At this time, the customer designates the payment start by a predetermined operation such as touching the button BUAC on the list screen SCA. In response to it, the processor 301 determines that the check-out start has been designated (YES in ACT118 of FIG. 10). The processing of the processor 301 then proceeds to ACT142. In ACT142, the processor 301 requests the payment from the mobile controller 3.

The processor 301 receives an operation of the customer as an effective operation in ACT115 or ACT118 as described above. That is, the processor 301 receives the operation of the customer who is the operator as the effective operation when the customer who is the operator is present inside the store which is the predetermined area and the movement of the customer is not detected. Thus, by the processor 301 performing the information processing based on the smartphone POS application APEA, the computer having the processor 301 as its central part functions as an operation means.

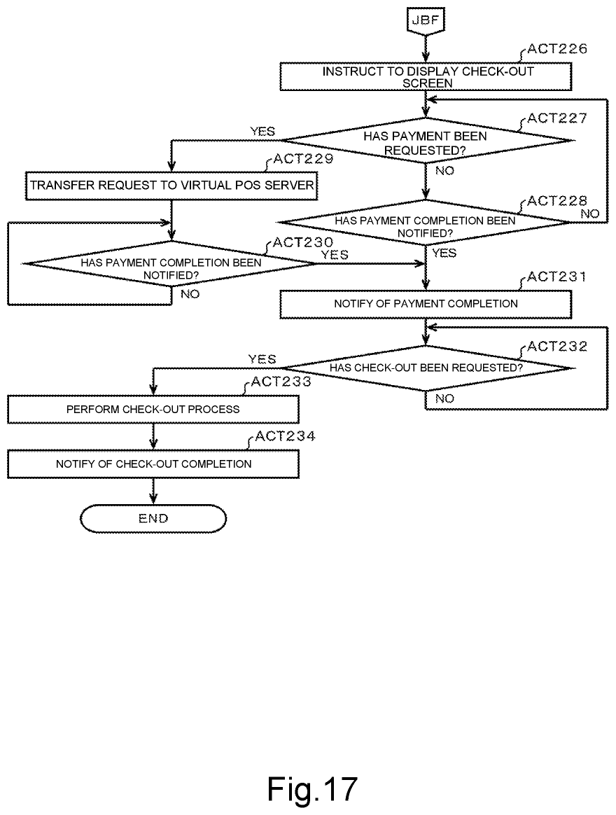

In the mobile controller 3, in a case where it is determined that check-out has been requested, i.e., in a case where the check-out has been requested from the user terminal 300 as described above (YES in ACT209 of FIG. 14), the processing of the processor 31 proceeds to ACT226 of FIG. 17. In ACT226, the processor 31 instructs the user terminal 300 to display the check-out screen.

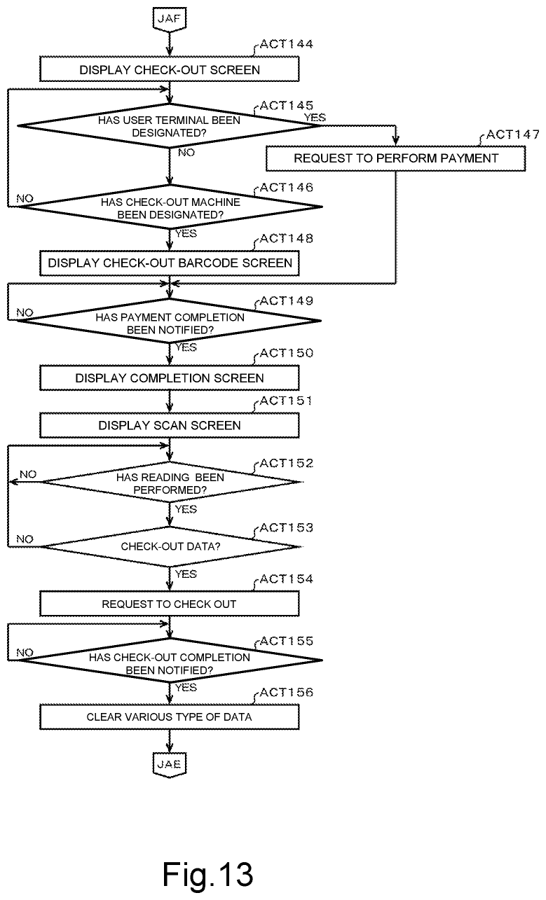

The processing of the processor 301 in the user terminal 300 proceeds to ACT143 after requesting the payment in ACT142 of FIG. 10. In ACT143, the processor 301 waits for the display of the check-out screen to be instructed while determining whether or not the display of the check-out screen has been instructed. In a case where the processor 301 has been instructed to display the check-out screen, i.e., in a case where the processor 301 confirms that the display of the check-out screen has been instructed as described above (Yes in ACT143), the processing of the processor 301 proceeds to ACT144 of FIG. 13. In ACT144, the processor 301 causes the touch panel 304 to display the check-out screen. The check-out screen is a screen for the customer to select which of the user terminal 300 and the check-out machine 5 is to be used for performing an operation for payment.

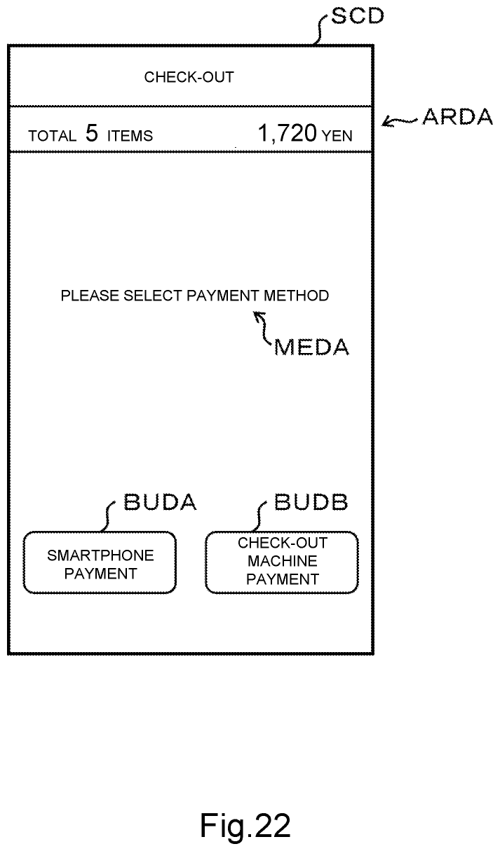

FIG. 22 is a diagram showing an exemplary check-out screen SCD. The check-out screen SCD includes a display area ARDA, a message MEDA, and buttons BUDA and BUDB. The display area ARDA displays the total number of purchased commodities and the total amount of money for the purchased commodities. The message MEDA is a character message that prompts the customer to designate which of the user terminal 300 and the check-out machine 5 is used for performing the operation for payment. The button BUDA is a soft key for the customer to designate the user terminal 300. The button BUDB is a soft key for the customer to designate the check-out machine 5.

The customer designates the user terminal 300 by a predetermined operation such as touching the button BUDA in a case where the customer wishes to perform an operation for payment through the user terminal 300. In a case where the customer wishes to perform the operation for payment through the check-out machine 5, the customer designates the check-out machine 5 by a predetermined operation such as touching the button BUDB.

In ACT145 of FIG. 13, the processor 301 determines whether or not the user terminal 300 has been designated. In a case where it is determined that the user terminal 300 has not been designated, i.e., in a case where the designation of the user terminal 300 cannot be confirmed (NO in ACT145), the processing of the processor 301 proceeds to ACT146. In ACT146, the processor 301 determines whether or not the check-out machine 5 has been designated. In a case where the check-out machine 5 has not been designated, i.e., in a case where the designation of the check-out machine 5 cannot be confirmed (NO in ACT146), the processing of the processor 301 returns to ACT145. As described above, the processor 301 waits for the user terminal 300 or the check-out machine 5 to be designated in ACT145 and ACT146. Then, in a case where it is determined that the user terminal 300 has been designated as described above (YES in ACT145), the processing of the processor 301 proceeds to ACT147.

In ACT147, the processor 301 requests the mobile controller 3 to perform payment. It should be noted that the processor 301 includes payment data such as a credit number and a user code for an online payment service, which are required for payment, in the request data for requesting payment.

Further, in a case where it is determined that the check-out machine 5 has been designated, i.e., in a case where the check-out machine 5 has been designated as described above (YES in ACT146), the processing of the processor 301 proceeds to ACT148. In ACT148, the processor 301 displays a check-out barcode screen on the touch panel 304. The check-out barcode screen displays a check-out barcode indicating data necessary for the check-out machine 5 to obtain data on the contents of the transaction from the virtual POS server 2. Although the detailed processing is not shown in the figure, the processor 301 obtains the check-out barcode from the virtual POS server 2 through the mobile controller 3 and causes the check-out barcode screen to display the check-out barcode.

The customer causes a scanner provided in the check-out machine 5, which is not used by other customers, to read the check-out barcode. In response to it, the check-out machine 5 obtains data related to the contents of the transaction from the virtual POS server 2 in accordance with the data represented by the check-out barcode, and performs processing for paying a payment amount calculated on the basis of this data. In a case where the payment has been completed, the check-out machine 5 notifies the virtual POS server 2 of the payment completion. In the virtual POS server 2, in a case where the payment completion has been notified from the check-out machine 5, the processor 21 notifies the mobile controller 3 of the payment completion. The payment completion in the check-out machine 5 may be directly notified from the check-out machine 5 to the mobile controller 3.

In the mobile controller 3, the processing of the processor 31 proceeds to ACT227 after instructing to display the check-out screen in ACT226 of FIG. 17. In ACT227, the processor 31 determines whether or not payment has been requested. In a case where it is determined that the payment has not been requested, i.e., in a case where the payment request cannot be confirmed (NO in ACT227), the processing of the processor 31 proceeds to ACT228. In ACT228, the processor 31 determines whether or not payment completion has been notified. In a case where it is determined that the payment completion has not been notified, i.e., in a case where the notification of the payment completion cannot be confirmed (NO in ACT228), the processing of the processor 31 returns to ACT227. As described above, the processor 31 waits for the payment request or the notification of the payment completion in ACT227 and ACT228. In a case where it is determined that the payment has been requested, i.e., in a case where the payment has been requested from the user terminal 300 as described above (YES in ACT227), the processing of the processor 31 proceeds to ACT229.

In ACT229, the processor 31 transfers the payment request to the virtual POS server 2 with a notification of the transaction code of the transaction to be processed. At this time, the processor 31 may transfer the request data transmitted from the user terminal 300 as it is to the virtual POS server 2 or may transmit the request data converted by a certain process to the virtual POS server 2.

In the virtual POS server 2, the processor 21 considers that the request based on the request data transmitted from the mobile controller 3 is a payment instruction input by the input device provided in the existing POS terminal, and calculates the price for the transaction identified by the notified transaction code by processing similar to that of the existing POS terminal. The processor 21 performs processing for paying the calculated price on the basis of the payment data. The processing for payment includes, for example, a payment request to a payment server (not shown). The processor 21 transmits result data indicating that the payment has been completed to the mobile controller 3.

In the mobile controller 3, the processing of the processor 31 proceeds to ACT230 after transferring the payment request in ACT229. In ACT230, the processor 31 waits for the payment completion to be notified from the virtual POS server 2 while determining whether or not the result data indicating that the payment has been completed has been received by the communication interface 34. In a case where it is determined that the result data indicating that the payment has been completed, which had been transmitted by the virtual POS server 2, has been received by the communication interface 34 (YES in ACT230), the processing proceeds to ACT231. In a case where it is determined that the payment completion in the check-out machine 5 has been notified, i.e., in a case where the payment completion in the check-out machine 5 has been notified as described above (Yes in ACT228), the processing of the processor 31 proceeds to ACT231. In ACT231, the processor 31 notifies the user terminal 300 of the payment completion.

In the user terminal 300, the processing of the processor 301 proceeds to ACT149 after requesting the payment to the mobile controller 3 in ACT147 of FIG. 13 or displaying the check-out barcode screen in ACT148. In ACT149, the processor 301 waits for the payment completion to be notified while determining whether or not the payment completion from the mobile controller 3 has been notified. In a case where it is determined that the payment completion has been notified from the mobile controller 3, i.e., in a case where the payment completion has been notified from the mobile controller 3 as described above (YES in ACT149), the processing of the processor 301 proceeds to ACT150. In ACT150, the processor 301 causes the touch panel 304 to display a completion screen. The completion screen is a screen for notifying the customer that the payment has been completed.

After confirming the completion screen, the customer declares that the completion screen has been confirmed by a predetermined operation such as touching a button displayed on the completion screen. In response to it, the processing of the processor 301 proceeds to ACT151. It should be noted that the processor 301 may proceed to ACT151 when the elapsed time reaches a predetermined time in a state in which the completion screen is displayed.

In ACT151, the processor 301 displays a scan screen for check-out on the touch panel 304. The scan screen for check-out is a screen for reading the two-dimensional code TCO for check-out. The processor 301 may, for example, activate the camera 305 and generate a scan image by superimposing a character message prompting the customer to read the two-dimensional code TCO and a line indicating a position to which the two-dimensional code TCO should be made to face on the image thus obtained by the camera 305.

When the scan screen for check-out is displayed on the touch panel 304, the customer directs the camera 305 to the two-dimensional code TCO such that the two-dimensional code TCO posted near the exit of the store is reflected on the scan screen.

In ACT152, the processor 301 waits for the two-dimensional code to be read while determining whether or not the two-dimensional code has been read. At this time, the processor 301 repeatedly analyzes the image obtained by the camera 305 and attempts to read the two-dimensional code. The reading of the two-dimensional code may be performed as a process based on the smartphone POS application APEA or may be performed as a process based on another application program for reading the two-dimensional code. In a case where it is determined that the two-dimensional code has been read (YES in ACT152), the processing of the processor 301 proceeds to ACT153.

In ACT153, the processor 301 determines whether or not the data indicated by the read two-dimensional code is the check-out data. In a case where it is determined that the data indicated by the read two-dimensional code is not the check-out data, i.e., in a case where the data indicated by the read two-dimensional code is not the check-out data (NO in ACT153), the processing of the processor 301 returns to ACT152. At this time, the processor 301 may cause the touch panel 304 to display a screen for notifying the customer that the erroneous two-dimensional code has been read.

On the other hand, in a case where it is determined that the data indicated by the read two-dimensional code is the check-out data, i.e., in a case where it can be confirmed that the data indicated by the read two-dimensional code is the check-out data (YES in ACT153), the processing of the processor 301 proceeds to ACT154. In ACT154, the processor 301 requests the mobile controller 3 to check out.

In the mobile controller 3, the processing of the processor 31 proceeds to ACT232 after notification of the payment completion in ACT231 of FIG. 17. In ACT232, the processor 31 waits for the check-out to be requested while determining whether or not the check-out has been requested from the user terminal 300. In a case where it is determined that the check-out has been requested from the user terminal 300, i.e., in a case where the check-out has been requested from the user terminal 300 as described above (YES in ACT232), the processor 31 proceeds to ACT233.

In ACT233, the processor 31 performs a check-out process. The check-out process is a process such as clearing data stored in the main memory 32 and the auxiliary storage device for managing the processed transaction. It should be noted that the virtual POS server 2 may terminate the process related to the corresponding transaction in response to the payment completion or may terminate the process related to the transaction in response to an instruction from the mobile controller 3. In the latter case, the processor 31 makes the above instruction to the virtual POS server 2 in the check-out process. Further, the store server 1, the virtual POS server 2, the mobile controller 3, another server (not shown), or the like may manage the history database indicating the history of the user's operation including incorrect barcode scan. In this case, the processor 31 performs a process for updating the history database in the check-out process to reflect the history of the operation related to the current transaction. In ACT234, the processor 31 notifies the user terminal 300 of check-out completion. Then, the processor 31 terminates the information processing shown in FIGS. 14 to 17.

In the user terminal 300, the processing of the processor 301 proceeds to ACT155 after requesting the check-out in ACT154 of FIG. 13. In ACT155, the processor 301 waits for the notification of the check-out completion from the mobile controller 3 while determining whether or not the check-out completion has been notified. In a case where it is determined that the check-out completion has been notified, i.e., in a case where the check-out completion has been notified from the mobile controller 3 as described above (YES in ACT155), the processing of the processor 301 proceeds to ACT156. In ACT156, the processor 301 clears various types of data temporarily used for the current shopping, such as the check-in data stored in ACT107 of FIG. 9. Thereafter, the processing of the processor 301 returns to ACT101 of FIG. 9.

As described above, the user terminal 300 according to the embodiment determines a commodity code that the customer attempts to cause the user terminal 300 to read when the customer is present inside the store and does not move, as an effective commodity code for registration. Therefore, when inputting the commodity code, the customer performs an operation in a stop state inside the store, and the customer can be prevented from being focused upon the operation during movement. The operation for causing the user terminal 300 to read the commodity code is frequently performed while the customer looks around the store. Therefore, the above-mentioned effect can be efficiently achieved by limiting this operation.

Also, the user terminal 300 does not receive operations for designating the start of scanning, the change in quantity, the cancel, the check-out start, and the scan cancel when the customer is present inside the store and is not moving. Therefore, the customer performs an operation for these operations in a stop state, and the customer can be prevented from being focused upon the operation during movement.

Further, the user terminal 300 performs a warning operation when an operation cannot be received as an effective operation because it is an operation by the customer who is present inside the store but moving. This allows the customer to recognize that the customer should stop for performing the operation.

Various modifications of this embodiment can be made as follows. In the above-mentioned embodiment, the example in which the commodity code of the commodity of the commodities displayed and sold in the store, which is to be purchased by the customer, is read by the user terminal 300 is shown. That is, the user terminal 300, the commodity code, the inside of the store, and the purchased commodity in the above-mentioned embodiment correspond to the information processing apparatus, the identifier, the predetermined area, and the transaction target, respectively. However, in a shopping mall, for example, it is possible to perform operation restriction similar to that of the above-mentioned embodiment also when the customer receives an order for a restaurant menu to eat or drink at a restaurant that the customer will visit in response to an operation at a cart terminal mounted on a shopping cart which is a facility of the shopping mall. In this example, the cart terminal, the identification code of the eating and drinking menu, the inside of the shopping mall, and the restaurant menu to eat or drink correspond to the information processing apparatus, the identifier, the predetermined area, and the transaction target, respectively. In this manner, the information processing apparatus, the identifier, the predetermined area, and the transaction target can be changed as appropriate.

Further, for example, in a case where the information processing apparatus is the shopping cart that is the facility of the shopping mall, the method of detecting the presence state of the customer can be changed as follows. The shopping cart may detect the presence of the customer in the predetermined area, for example, when communication with an access point provided in the shopping mall is possible, or when a beacon signal transmitted from a beacon transmitter provided in the shopping mall is receivable. As described above, the method of detecting the presence state of the customer can be variously changed.

In a case where the information processing apparatus is the cart terminal, it is also possible to measure the movement speed of the customer as the movement speed of the shopping cart and to detect the movement of the customer on the basis of the movement speed. Thus, the method of detecting the movement of the customer can be variously changed.

The user terminal 300 may be operated mainly as a user interface, and the processing in ACT114, ACT119 of FIG. 10 and ACT123, ACT126 of FIG. 11 and the control processing for the warning operation in ACT120 of FIG. 10 and ACT127 of FIG. 11 may be performed by another information processing apparatus such as the mobile controller 3, for example.

The processor 301 may perform processing similar to that of ACT114, ACT119, and ACT120 of FIG. 10 also in the standby state of ACT102 and ACT103 of FIG. 9, the standby state of ACT105, the standby state of ACT133 and ACT134 of FIG. 12, the standby state of ACT138 and ACT139, the standby state of ACT145 and ACT146 of FIG. 13, or the like. Further, the processor 301 may perform processing similar to that of ACT114, ACT119, and ACT120 of FIG. 10 in the standby state for the operations not shown in the information processing of FIGS. 9 to 13. The processor 301 may omit the processing of ACT113, ACT114, ACT119, and ACT120 of FIG. 10.

Each function realized by the processor 11, 21, 31, 41, or 301 in the information processing can be realized by hardware that performs information processing not based on a program, such as a logic circuit. Alternatively, each of the above-mentioned functions may be realized by combining software control with the hardware such as the logic circuit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus that is carried by an operator inside and outside a predetermined area and processes information for a transaction in accordance with an operation of the operator inside the predetermined area, the information processing apparatus comprising:
an input device that inputs an identifier of a transaction target in accordance with an operation performed by the operator;
a first detection device that detects whether or not the operator is present inside the predetermined area;
a second detection device that detects a movement of the operator; and
a processor that determines the identifier input by the input device as the identifier of the transaction target when the first detection device has detected presence of the operator and the second detection device has not detected the movement of the operator.

2. The information processing apparatus according to claim 1, further comprising
a warning device that performs a predetermined warning operation on the operator, wherein
the processor causes the warning device to perform the predetermined warning operation in accordance with input of the identifier by the input device when the first detection device has detected the presence and the second detection device has detected the movement of the operator.

3. The information processing apparatus according to claim 1, wherein
the processor receives an operation performed by the operator on the input device as an effective operation when the first detection device has detected the presence of the operator and the second detection device has not detected the movement of the operator.

4. The information processing apparatus according to claim 3, further comprising
a warning device that performs a predetermined warning operation on the operator, wherein
the processor causes the warning device to perform the predetermined warning operation when the first detection device has detected the presence of the operator and the second detection device has detected the movement of the operator, in accordance with an operation performed by the operator on the input device.

5. The information processing apparatus according to claim 4, wherein
the warning device outputs a predetermined sound as the warning operation.

6. The information processing apparatus according to claim 1, wherein
the first detection device includes a wireless communication device that establishes wireless communication with an external mobile controller,
the processor transmits, to the external mobile controller via the wireless communication device, data for requesting check-in for the operator to enter the predetermined area, and
the wireless communication device determines that it has been detected that the operator is present inside the predetermined area when notification data of check-in completion has been received as a response to transmission of the data for requesting the check-in.

7. The information processing apparatus according to claim 6, wherein
the input device includes a camera, and
the processor
obtains data for check-in for entering the predetermined area from an image taken by the camera when the operator enters the predetermined area, and
includes the obtained data for check-in in the data for requesting the check-in and transmits the data for requesting the check-in via the wireless communication device.

8. The information processing apparatus according to claim 7, wherein
the processor
obtains the identifier from the image taken by the camera, and
determines the obtained identifier as the identifier of the transaction target when the processor determines that the presence of the operator has been detected and the second detection device has not detected the movement of the operator.

9. The information processing apparatus according to claim 1, wherein
the input device includes a camera and a touch panel, and
the processor
causes the touch panel to display the image taken by the camera, and
causes the touch panel to display a predetermined warning message superimposed on the taken image in accordance with an operation performed by the operator on the input device when the first detection device has detected the presence of the operator and the second detection device has detected the movement of the operator.

10. An information processing method for an information processing apparatus that is carried by an operator inside and outside a predetermined area and processes information for a transaction in accordance with an operation of the operator inside the predetermined area, the information processing method comprising:
inputting an identifier of a transaction target via an input device operated by the operator;
detecting whether or not the operator is present inside the predetermined area by a first detection device;
detecting a movement of the operator by the first detection device; and
determining the identifier input by the input device as the identifier of the transaction target when the first detection device has detected presence of the operator and the second detection device has not detected the movement of the operator.
